(19) United States
(12) Patent Application Publication
(10) Pub. No.: US 2026/0258216 A1
(43) Pub. Date: Sep. 3, 2026

(54) PROCESS FOR RECYCLING PLASTICS COMPRISING THE SEPARATION OF IMPURITIES FROM A POLYMER SOLUTION BY DECANTATION

(71) Applicant: IFP Energies nouvelles, Rueil-Malmaison (FR)

(72) Inventors: Yacine HAROUN, Rueil-Malmaison Cedex (FR); Stephane GIRARDON, Rueil-Malmaison Cedex (FR); Deisy MEJIA MENDEZ, Rueil-Malmaison Cedex (FR); Wilfried WEISS, Rueil-Malmaison Cedex (FR)

(73) Assignee: IFP Energies nouvelles, Rueil-Malmaison (FR)

(21) Appl. No.: 19/162,083

(22) PCT Filed: Feb. 14, 2024
(86) PCT No.: PCT/EP2024/053660

§ 371 Date: Sep. 4, 2025

(30) Foreign Application Priority Data
Mar. 8, 2023 (FR) FR2302122

(51) Int. Cl. C08J 11/06

(52) U.S. Cl. CPC C08J 11/06; C08J 2323/12

(57) ABSTRACT

A process for treating a plastic feedstock, by:
a) dissolving the plastic feedstock in a dissolution solvent between 100° C. and 300° C. and between 1.0 and 100.0 MPa absolute, to obtain a crude polymer solution;
b) decanting the crude polymer solution to obtain a decanted polymer solution and a tailings fraction, at 100-300° C. and at 1.0-100.0 MPa absolute and using at least one decanter, an effluent enriched in polymer solution being recovered at the outlet of each the at least one decanter to constitute the decanted polymer solution, a tailings stream being recovered at the outlet of each the at least one decanter to constitute the tailings fraction, the liquid surface velocity in the decanter ranging between 1×10⁻⁷ and 1.000×10⁻² m/s;
c) solvent-polymer separation, to obtain a stream of purified thermoplastics;
and a device for carrying out such a process.

### TECHNICAL FIELD

The present invention relates to a process for treating plastics, in particular used plastics, in order to obtain a stream of purified thermoplastic polymers which can be upgraded, for example in the manufacture of new plastic objects. More particularly, the present invention concerns a process for purifying a plastic feedstock, notably obtained from plastic waste, comprising thermoplastic polymers and in particular polyolefins, for example polyethylene and/or polypropylene, by dissolving the targeted thermoplastics in a solvent and then purifying the polymer solution obtained. Said process in particular comprises a step of purifying the polymer solution obtained by decanting at least some of the impurities, thus making it possible to recover a stream of purified thermoplastics at the outlet of the process according to the invention.

### PRIOR ART

Plastics obtained from collection and sorting channels can be upgraded according to various channels.

“Mechanical” recycling makes it possible to partly reuse certain waste either directly in new objects or by mixing the streams of mechanically sorted plastic waste with streams of virgin polymers. This type of upgrading is limited since, although it makes it possible to obtain a stream concentrated in terms of a particular type of polymer, mechanical sorting does not make it possible to remove the impurities that are at least partly trapped in the polymer matrix, for instance the additives, such as the fillers, colourants, pigments and metals. Indeed, additives are compounds conventionally introduced into polymer formulations to give the material, and thus the final objects, the desired properties, for example high mechanical strength, a particular colour, etc.

“Chemical” recycling is directed towards at least partly reforming monomers via a sequence of steps that is generally complex. For example, plastic waste may undergo a pyrolysis step and the pyrolysis oil recovered, generally after purification, may be at least partly converted, for example, into olefins by steam cracking. These olefins may then be polymerized. This type of sequence may be suitable for feedstocks that have undergone little sorting or for sorting centre refuse but it generally requires a large consumption of energy notably due to the high temperature treatments.

Another route for recycling plastic waste consists in at least partly dissolving the plastics, in particular the thermoplastics, for the purpose of purifying them by removing the impurities, for example the additives such as the fillers, colourants, pigments and metals and/or the polymers from the feedstock other than the targeted polymer(s).

Several studies thus present various methods for treating plastic waste by dissolution and purification.

US 2017/002110 describes a particular method for purifying a polymer feedstock notably obtained from plastic waste by dissolving the polymer in a solvent, under particular temperature and pressure conditions, followed by placing the polymer solution obtained in contact with a solid.

WO 2018/114047 proposes, for its part, a method for selectively dissolving a particular polymer of a plastic in a solvent at a dissolution temperature close to the boiling point of the solvent.

However, the process of document WO 2018/114047 does not allow impurities, for example additives, to be treated and separated effectively.

US 2018/0208736 proposes a treatment process by liquefaction of thermoplastics in a solvent followed by separating out the insoluble matter and/or the gases. The process of US 2018/0208736 does not make it possible to efficiently process the impurities and in particular the impurities that are soluble in the solvent. The purpose of US 2018/0208736 is to provide a plastic composition that can be used in a cracking process, so high purity is not sought. In fact, US 2018/0208736 indicates, for example, that approximately 2% by weight of impurities remain after treatment in a reactor of a feedstock (comprising approximately 3% by weight of solid foreign materials relative to the total weight of the solid compounds of the feedstock) by dissolution in docosane (which has a boiling point of 369° C.) at 150-300° C. and 1.1-1.5 bar (i.e. 0.11-0.15 MPa) and then decantation in an unstirred zone of said reactor.

WO 2018/118579 describes a method for purifying a polymeric feedstock notably obtained from plastic waste by dissolving the polymer in a solvent in a stirred reactor, followed by a sedimentation step. More particularly, WO 2018/118579 illustrates the purification of a feedstock composed of post-consumer polypropylene by dissolving it in n-butane in an autoclave stirred at 140° C. and 900 psig (6.21 MPa), followed by a sedimentation phase after the stirring in the autoclave has stopped. The polymer solution obtained is optionally passed through beds of solids and then depressurized so as to be able to separate at least some of the butane solvent from the polypropylene.

The present invention is directed towards improving these processes for treating thermoplastics by dissolution in a solvent. In particular, the present invention is directed towards optimizing the removal, advantageously the continuous removal, of impurities from a plastic feedstock and recovering a purified and notably decolourized and deodourized stream of thermoplastics, in particular of polyolefins, while at the same time limiting the number of operations in the process performed and notably the number of separation and/or purification steps of said process. The present invention is thus directed towards efficiently removing impurities, for example additives, from a plastic feedstock, which in particular comprises thermoplastics, and in particular polyolefins, so as to continuously obtain a stream of purified thermoplastics, in particular a stream of purified polyolefins, which can be reused, for example, as base polymer in the manufacture of new plastic objects instead of virgin resin, by performing a continuous and simple process.

### SUMMARY OF THE INVENTION

The invention relates to a process for treating a plastic feedstock, comprising:
a) a step of dissolving the plastic feedstock in a dissolution solvent, step a) being performed at a dissolution temperature of between 100° C. and 300° C. and at a dissolution pressure of between 1.0 and 100.0 MPa absolute, to obtain at least one crude polymer solution;
b) a step of decanting the crude polymer solution, to obtain a decanted polymer solution and a tailings fraction,
step b) being operated at a temperature of between 100° C. and 300° C. and a pressure of between 1.0 and 100.0 MPa absolute, and using at least one decanter,
when step b) comprises several decanters, said decanters operate in series or in parallel,
the decanter or the first decanter of the decanters in series or each decanter in parallel being fed with at least one fraction of said crude polymer solution,
wherein an effluent enriched in polymer solution is recovered at the outlet of the or each decanter,
wherein the effluent enriched in polymer solution recovered at the outlet of said decanter or of the last decanter of the decanters operating in series or else all the effluents enriched in polymer solution recovered at the outlet of each decanter operating in parallel, constitutes said decanted polymer solution,
a tailings stream being recovered at the outlet of the or of each decanter, all the tailings streams recovered constituting said tailings fraction,
said at least one decanter having a liquid surface velocity ranging between 1×10⁻⁷ and 1.000×10⁻² m/s; then
c) a step of solvent/polymer separation, to obtain at least one stream of purified thermoplastic polymers.

The advantage of the process according to the invention is that of proposing a simple and efficient treatment of a plastic feedstock, and notably of plastic waste in particular obtained from collection and sorting channels, so as to recover the thermoplastic polymers, in particular the polyolefins, or even selectively polypropylene or polyethylene, which it contains in order to be able to recycle them into any type of application. The process according to the invention, which comprises the dissolution of the thermoplastics followed by a particular decantation step, notably continuously, in fact makes it possible to obtain, simply and advantageously continuously, a stream of purified thermoplastics having a sufficiently low content of impurities so that the stream of purified thermoplastics can be used in any type of plastic formulation in place of virgin resin. More particularly, the process according to the invention allows the removal of at least 70% by weight, preferentially at least 80% by weight, of the impurities, and in particular of the inorganic impurities, contained in the plastic feedstock. The process according to the invention also makes it possible to remove organic compounds and notably insoluble polymers other than the targeted thermoplastics. Furthermore, very advantageously, the stream of purified thermoplastics, in particular of purified polyolefins, obtained at the end of the process is less coloured or is even decolourized relative to the plastic feedstock fed into the process according to the invention. In very special cases, the process according to the invention makes it possible to obtain a stream of purified thermoplastics, notably the stream of purified polyolefins, or even polypropylene or polyethylene, comprising 5% by weight of impurities or less, very advantageously 1.0% by weight of impurities or less, even more preferentially having a content of less than or equal to 0.5% by weight of impurities.

The process according to the invention thus proposes a simple scheme corresponding to a sequence of operations, in particular comprising at least dissolution and decantation, which makes it possible to remove at least some of the impurities from the plastic waste, notably at least some of the additives, and to recover purified thermoplastics, in particular the purified thermoplastics targeted, comprising few impurities and advantageously a very low content of solvent (preferably less than or equal to 10% by weight, preferentially less than or equal to 1% by weight), so as to be able to upgrade the plastic waste by recycling said purified thermoplastics.

The invention also has the advantage of participating in the recycling of plastics and in conserving the fossil resources, by enabling the upgrading of plastic waste. Specifically, it allows the purification of plastic waste for the purpose of obtaining a stream of purified thermoplastic polymers, in particular purified polyolefins, or even purified polypropylene or polyethylene, with a reduced content of impurities, and notably decolourized and deodourized, which may be reused for forming new plastic objects. The purified thermoplastics obtained may thus be used directly in formulations as a mixture with additives, for example plasticizers, colourants, pigments, fillers, etc., in place of or as a mixture with virgin resins, for the purpose of obtaining plastic products having aesthetic, mechanical or rheological working properties which facilitate their reuse and their upgrading.

The present invention also relates to a device for treating a plastic feedstock to obtain a stream of purified thermoplastic polymers, which comprises:
means for placing in contact and at least partially dissolving the plastic feedstock in a dissolution solvent, so as to obtain a crude polymer solution;
a decanting device comprising at least one decanter, in which a liquid surface velocity ranges between 1×10⁻⁷ and 1.000×10⁻² m/s, and preferably the injection velocity is of less than or equal to 1.00 m/s,
where the decanting device comprises several decanters, said decanters operating in series or in parallel,
said at least one decanter being a vertical or horizontal decanter, preferably cylindrical or generally cylindrical in shape, preferably with a ratio L/D between the total height or length L of the decanter and the diameter D of the decanter of between 0.5 and 12, preferably between 1.0 and 6.0,
said decanter(s) comprising a polymer solution feed point,
said at least one decanter comprising a first outlet for an effluent enriched in polymer solution and a second outlet for a tailings stream,
when the decanting device comprises several decanters in series, the first outlet of the downstream decanter is advantageously connected to the feed point of the decanter directly upstream, except for the last decanter in the series for which the first outlet is connected to means located downstream of the decanting device,
when the decanting device comprises several decanters in parallel, all of said first outlets of said decanters are connected to one another and to a mixing system for mixing all of the effluents enriched in polymer solution that are recovered at the outlet of said decanters in parallel, said mixing system being connected to means located downstream of the decanting device;
optionally an additional purification system, located downstream of the decanting device;
solvent-polymer separation means, located downstream of the decanting device, for separating a stream of solvent and a stream of purified thermoplastic polymers.

According to one embodiment, said at least one decanter is a vertical decanter, in which:
the feed point of said decanter is located between one quarter of the height of said decanter and three quarters of the height of said decanter, said feed point then defining two zones in the vertical decanter in question, an upper zone between the feed point and the top of the vertical decanter, and a lower zone between the feed point and the bottom of the vertical decanter,
the first outlet of said decanter is advantageously located in the upper zone of the vertical decanter in question, and the second outlet is located in the lower zone of the vertical decanter.

According to another embodiment, said at least one decanter is a horizontal decanter, in which:
the feed point of said decanter is located towards one end of the horizontal decanter in question,
the first outlet and the second outlet of said decanter are located towards the end opposite to the feed point.

### DESCRIPTION OF THE EMBODIMENTS

According to the present invention, the expressions “of between . . . and . . . ” and “between . . . and . . . ” are equivalent and mean that the limit values of the interval are included in the described range of values. If such is not the case and if the limit values are not included in the range described, such information will be introduced by the present invention.

For the purposes of the present invention, the various ranges of parameters for a given step, such as the pressure ranges and the temperature ranges, can be used alone or in combination.

For example, for the purposes of the present invention, a range of preferred pressure values can be combined with a range of more preferred temperature values.

Hereinafter, particular embodiments of the invention are described. They can be employed separately or combined together, without limitation of combinations when this is technically achievable.

According to the present invention, the pressures are absolute pressures and are given in MPa absolute (or MPa abs).

The terms “upstream” and “downstream” should be understood as a function of the general flow of the fluid(s) or stream(s) under consideration in the process.

In the present description, the terms “polymer”, “thermoplastic polymer” and “thermoplastic” may be used interchangeably.

The term “polyolefins” refers to any type of homopolymer and/or copolymer, and mixtures thereof, having olefins as the basic unit. More particularly, polyolefins can be polyethylene homopolymers, designated by the abbreviation PE, of any range (for example high density, also called HDPE, or low density, called LDPE), polypropylene homopolymers, designated by the abbreviation PP, copolymers thereof and/or mixtures thereof.

The term “additives” is a term conventionally used in the field of polymers and in particular in the field of polymer formulations. The additives introduced into the polymer formulations may be, for example, plasticizers, fillers (which are organic or mineral solid compounds used for modifying the physical, thermal, mechanical and/or electrical properties of the polymer materials or for reducing the cost price thereof), reinforcing agents, colourants, plasticizers, pigments, hardeners, flame retardants, combustion retardants, stabilizers, antioxidants, UV absorbers, antistatic agents, etc.

The additives correspond to at least some of the impurities of the plastic feedstock to be treated and which the treatment process according to the invention makes it possible to at least partly remove. Other types of impurities may be use-related impurities, for instance metal impurities, papers/cardboard, biomass, polymers other than the targeted polymer(s), etc.

Thus, according to the invention, the impurities which the process according to the invention makes it possible to at least partly remove comprise the additives conventionally used in polymer formulations and generally use-related impurities derived from the life cycle of the plastic objects and materials, and/or derived from the waste collection and sorting circuit. Said impurities may be impurities of metallic, organic or mineral type; they may be packaging residues, food residues or compostable residues (biomass). These use-related impurities may also comprise glass, wood, cardboard, paper, aluminium, iron, metals, tyres, rubber, silicones, rigid polymers, thermosetting polymers, thermoplastics of a nature different from that of the targeted thermoplastics (in particular from that of the targeted polyolefins), household, chemical or cosmetic products, spent oils, water.

According to the invention, a polymer solution is a solution comprising the dissolution solvent and at least the targeted thermoplastic polymers, notably the targeted polyolefins, which are dissolved (i.e. in particular solvated and dispersed) in said dissolution solvent, the dissolved polymers being initially present in the feedstock. The polymer solution may also comprise impurities which are insoluble (and suspended in the polymer solution) and optionally soluble (and dissolved in the dissolution solvent). Depending on the steps of the process according to the invention, said polymer solution may thus comprise impurities in the form of insoluble particles which are advantageously in suspension in said polymer solution, optionally soluble impurities dissolved in the dissolution solvent, and/or optionally another liquid phase that is immiscible with said polymer solution.

It is well known that the boiling point of a compound varies with the operating pressure. However, without further indication, i.e. without indication of the pressure, the boiling point of the compound under consideration, in particular of the dissolution solvent, is to be understood as the boiling point of said compound, in particular of said dissolution solvent, at atmospheric pressure (in particular equal to 0.1 MPa). Thus, the boiling point characterizing the dissolution solvent is to be understood as the boiling point of said dissolution solvent at atmospheric pressure (in particular equal to 0.1 MPa).

The critical temperature and critical pressure of a solvent, in particular of the dissolution solvent, are specific to said solvent and depend on the nature of the solvent under consideration. For a pure substance, the critical temperature and the critical pressure of a pure substance are, respectively, the temperature and the pressure of the critical point of said pure substance. As is well known to those skilled in the art, at and above the critical point, the pure substance under consideration is in supercritical form or in the supercritical state; it may then be referred to as a supercritical fluid.

The invention thus relates to a process for treating a plastic feedstock, preferably composed of plastic waste, and advantageously comprising thermoplastic polymers, more particularly polyolefins, said process comprising, and preferably consisting of:
a) a step of dissolving the plastic feedstock in a dissolution solvent, preferably comprising at least one hydrocarbon-based compound, preferably an aliphatic and preferably paraffinic compound, advantageously having a boiling point of between −50 and 250° C., preferably between −15 and 150° C., preferentially between −1 and 110° C. and preferably between 2° and 100° C., preferably in a weight ratio between the dissolution solvent and the plastic feedstock of between 0.2 and 100.0, preferably between 0.3 and 20.0, preferably between 1.0 and 10.0, even more preferentially between 3.0 and 7.0, to obtain at least one crude polymer solution,
step a) advantageously being operated at a dissolution temperature of between 100° C. and 300° C., preferably between 15° and 250° C., and a dissolution pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute;
b) a step of decanting the crude polymer solution, to obtain a decanted polymer solution and a tailings fraction,
step b) being operated at a temperature of between 100° C. and 300° C., preferably between 15° and 250° C., and a pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute,
step b) involving at least one decanter, preferably between one and ten decanters, preferentially between two and five decanters, advantageously operating in series or in parallel, preferably in parallel,
the (or each) decanter in particular being a vertical or horizontal decanter, advantageously cylindrical or generally cylindrical in shape, preferably with a ratio L/D between the total height or length L of the decanter and the diameter or width D of the decanter of between 0.5 and 12, preferably between 1.0 and 6.0,
said decanter or the first decanter of the decanters in series or else each decanter in parallel being fed with at least a fraction, or all, of said crude polymer solution advantageously at a feed point located on the decanter under consideration,
an effluent enriched in polymer solution being recovered at the outlet of the or each decanter, the effluent enriched in polymer solution recovered at the outlet of said decanter or of the last decanter of the decanters in series or else all the effluents enriched in polymer solution recovered at the outlet of each decanter in parallel, constituting said decanted polymer solution,
a tailings stream being recovered, in particular continuously or batchwise, at the outlet of the or of each decanter, all the tailings streams recovered constituting said tailings fraction,
said decanter(s) having:
   a liquid surface velocity ranging between 1×10⁻⁷ and 1.000×10⁻² m/s, preferably between 1.0×10⁻⁶ and 1.000×10⁻² m/s, preferentially between 1.0×10⁻⁵ and 6.000×10⁻³ m/s, preferably between 2.0×10⁻⁵ and 5.000×10⁻³ m/s, very preferably between 2.0×10⁻⁵ and 9.00×10⁻⁴ m/s, in particular between 2.0×10⁻⁵ and 5.00×10⁻⁴ m/s,
   preferably, an injection speed of less than or equal to 1.00 m/s, preferably less than or equal to 0.10 m/s, preferentially less than or equal to 0.05 m/s, and preferably greater than or equal to 0.001 m/s;
each decanter being very advantageously operated for a residence time of between 1 and 200 hours, preferably between 1 hour and 50 hours, and preferably with a filling ratio of between 70% and 100% of the total volume of the decanter under consideration;
b′) optionally, a step of purifying the decanted polymer solution, comprising:
b′1) an additional solid-liquid separation sub-step, to obtain at least one clarified polymer solution; and/or
b′2) washing of the decanted or optionally clarified polymer solution by contact with a dense solution, to obtain at least one washing effluent and a washed polymer solution; and/or
b′3) extraction of the impurities with an extraction solvent, to obtain at least one extracted polymer solution and one used solvent; and/or
b′4) adsorption of the impurities by contact with a solid adsorbent, to obtain at least one refined polymer solution;
the purification step making it possible to obtain a purified polymer solution which advantageously corresponds to a clarified or washed or extracted or refined polymer solution; and then
c) a solvent-polymer separation step to obtain at least one stream of purified thermoplastic polymers, more particularly at least one stream of purified polyolefins, or even at least one stream of purified polypropylene or at least one stream of purified polyethylene.

### The Feedstock

The feedstock of the process according to the invention, known as the plastic feedstock, comprises plastics which themselves more particularly comprise thermoplastic polymers, such as polyolefins. Preferably, the plastic feedstock comprises between 50% and 100% by weight and with preference between 70% and 100% by weight of plastics.

The plastics included in the feedstock of the process according to the invention are generally production waste and/or “post-consumer” waste plastic objects, notably household plastic waste, plastic waste from the construction industry, plastic waste from motor vehicles or from any type of transport or electrical and electronic equipment waste. Preferably, the plastic waste is obtained from collection and sorting channels. Plastics or plastic materials comprise polymers that are mixed with additives, so as to provide specific properties to the materials, for the purpose of constituting, after forming into shape, various objects (for example, injection-moulded parts, tubes, films, fibres, fabrics, mastics, coatings, etc.). The additives used in plastics may be organic compounds or inorganic compounds. They are, for example, fillers, colourants, pigments, plasticizers, property modifiers, combustion retardants, etc.

The feedstock of the process according to the invention in particular comprises thermoplastic polymers, preferably at least 50% by weight, preferentially at least 70% by weight, preferably at least 80% by weight and very preferably at least 90% by weight of thermoplastic polymers, 100% being advantageously the maximum upper limit. The thermoplastic polymers included in the plastic feedstock and targeted by the process according to the invention may be alkene polymers, diene polymers, vinyl polymers and/or styrene polymers. Preferably, the thermoplastic polymers included in the plastic feedstock and targeted by the process according to the invention are polyolefins, such as polyethylene (PE), polypropylene (PP) and/or copolymers of ethylene and of propylene, or mixtures thereof. Preferably, the plastic feedstock comprises at least 80% by weight, preferably at least 85% by weight, preferably at least 90% by weight, of polyolefins relative to the total weight of the plastic feedstock, 100% advantageously being the maximum upper limit. The process according to the invention is thus most particularly directed towards purifying and recovering the polyolefins contained in the feedstock to be able to reuse them in various applications. According to a particular embodiment, the plastic feedstock comprises a mixture of polypropylene (PP) and polyethylene (PE), in particular at least 80% by weight, preferably at least 85% by weight, preferably at least 90% by weight, of a mixture of polypropylene (PP) and polyethylene (PE), relative to the total weight of the plastic feedstock. The polyethylene may in particular be high-density polyethylene (HDPE). In this particular embodiment, said mixture comprises for example between 5% and 95% by weight of PP and between 5% and 95% by weight of PE, in particular HDPE, or between 50% and 95% by weight of PP and between 5% and 50% by weight of PE, in particular HDPE. In this particular embodiment, the process according to the invention therefore aims to purify and recover specifically the PP and/or the PE.

The plastic feedstock may comprise mixtures of polymers, in particular thermoplastics other than the targeted polyolefins, additives advantageously used for formulating the plastic material and generally use-related impurities originating from the life cycle of the plastic materials and objects and/or originating from the waste collection and sorting circuit, these compounds being collectively considered as impurities. The feedstock of the process according to the invention generally comprises less than 50% by weight of impurities, preferably less than 20% by weight of impurities, preferably less than 10% by weight of impurities. The plastic feedstock may comprise, for example, at least 1% by weight of impurities, or even at least 5% by weight of impurities.

The plastic feedstock may advantageously be pretreated prior to the process so as to at least remove all or some of the “coarse” impurities, i.e. impurities in the form of particles greater than or equal to 10 mm, preferably greater than or equal to 5 mm, or even greater than or equal to 1 mm in size, for example impurities such as wood, paper, biomass, iron, aluminium, glass, etc., and so as to put it into form, generally into the form of divided solids so as to facilitate the treatment in the process. This pretreatment may comprise a grinding step, a step of washing at atmospheric pressure and/or a drying step. This pretreatment may be performed at a different site, for example in a waste collection and sorting centre, or at the same site where the treatment process according to the invention is performed. Preferably, this pretreatment makes it possible to reduce the content of impurities to less than 20% by weight, preferably less than 15% by weight, preferably less than 10% by weight, the percentages being given relative to the weight of the plastic feedstock treated by means of the process according to the invention. At the end of the pretreatment, the feedstock is generally stored in the form of divided solids, for example in the form of ground material, flakes or powder or granules, so as to facilitate the handling and transportation into the process.

### Dissolution Step a)

According to the invention, the process comprises a dissolution step a) in which the plastic feedstock is placed in contact with a dissolution solvent and the thermoplastics contained therein, the separation and purification of which are advantageously targeted; in particular, the polyolefins contained therein are dissolved in the dissolution solvent, to obtain at least one, preferably one, crude polymer solution.

The term “dissolution” should be understood as meaning any phenomenon leading to the production of at least one solution of thermoplastic polymers, i.e. a liquid (or fluid) comprising the targeted thermoplastic polymers dissolved in the dissolution solvent. Those skilled in the art are fully aware of the phenomenon or phenomena involved in the dissolution of polymers and which involve at least mixing, solvating, dispersion, homogenization and disentangling of the thermoplastic polymer chains.

In the course of and at the end of the dissolution step a), the pressure and temperature conditions make it possible to maintain the dissolution solvent, at least partly and preferably totally, in liquid form or optionally in supercritical form, whereas the soluble fraction of the plastic feedstock, in particular the targeted thermoplastic polymers and most particularly the targeted polyolefins, and, for example, at least a portion of the impurities, is advantageously at least partly and preferably totally dissolved in the dissolution solvent. In other words, the temperature and pressure conditions in step a) avoid or at least limit the possibility of the dissolution solvent being in gaseous form.

The dissolution solvent is an organic solvent or a mixture of organic solvents. Advantageously, the dissolution solvent comprises, and preferably consists of, at least one preferably aliphatic and in particular paraffinic (i.e. saturated), preferably linear or branched hydrocarbon-based compound. Preferably, the dissolution solvent comprises at least 80% by weight, preferentially at least 95% by weight, preferably at least 98% by weight of at least one preferably aliphatic and in particular paraffinic, preferably linear or branched hydrocarbon-based compound, the percentages being expressed relative to the total weight of the dissolution solvent (100% being the maximum). Preferably, the dissolution solvent comprises at least one preferably aliphatic and in particular paraffinic hydrocarbon-based compound, having a boiling point (at atmospheric pressure, in particular at 0.1 MPa) of between −50 and 250° C., preferably between −15 and 150° C., preferentially between −1 and 110° C. and preferably between 2° and 100° C. Preferably, the dissolution solvent comprises, preferably consists of, at least one preferably aliphatic and in particular paraffinic, preferably linear or branched hydrocarbon-based compound, containing between 3 and 12 carbon atoms, preferentially between 4 and 8 carbon atoms, and very preferably containing 6, 7 or 8 carbon atoms. For example, the dissolution solvent comprises a compound chosen from the isomers of butane, pentane, hexane, heptane and octane. The dissolution solvent may comprise, preferably consist of, a mixture of isomers of butane, pentane, hexane, heptane and/or octane, and preferably in a content of said mixture of isomers in the dissolution solvent of greater than or equal to 80% by weight, preferably greater than or equal to 95% by weight, preferably greater than or equal to 98% by weight, relative to the total weight of the dissolution solvent. According to a very preferred embodiment, the dissolution solvent comprises, preferably consists of, an isomer or a mixture of isomers of hexane, heptane and/or octane. Very advantageously, a preferred hydrocarbon-based compound for the dissolution solvent comprises a paraffinic aliphatic compound, having a critical temperature (temperature at the critical point of said pure hydrocarbon-based compound) of preferably between 95 and 350° C., preferentially between 13° and 300° C., with preference between 18° and 285° C.

Preferably, the dissolution step a) is fed with the plastic feedstock and a dissolution solvent in a weight ratio between the dissolution solvent and the plastic feedstock of between 0.2 and 100.0, preferably between 0.3 and 20.0, preferably between 1.0 and 10.0, even more preferentially between 3.0 and 7.0.

Advantageously, the dissolution solvent which feeds the dissolution step a) is in liquid or possibly supercritical form. Advantageously, it can be preheated, preferably to a temperature of between 10° and 300° C., preferentially between 15° and 250° C., prior to its introduction into step a), in particular prior to its introduction into the contacting section and optionally into the dissolution section, so as to facilitate the heating of the plastic feedstock and/or avoid a temperature drop of the material stream in the contacting and optionally dissolution sections of step a).

Advantageously, the dissolution solvent comprises, and preferably consists of, fresh solvent (or a supply of fresh solvent) and/or a stream of recycled solvent obtained from a subsequent step of the process, preferably at least partly obtained from the solvent-polymer separation step c).

Very advantageously, the dissolution step is operated at a temperature, known as the dissolution temperature, of between 100° C. and 300° C., preferably between 15° and 250° C., and preferably a pressure, known as the dissolution pressure, of between 1.0 and 100.0 MPa absolute, preferably between 1.0 and 25.0 MPa absolute, preferentially between 1.5 and 18.0 MPa absolute and very preferably between 2.0 and 15.0 MPa absolute. The temperature and pressure can change during the dissolution step from atmospheric conditions or the conditions of introduction of the plastic feedstock and/or dissolution solvent into the process, to reach the dissolution conditions, i.e. the dissolution temperature, in particular between 10° and 300° C., preferably between 15° and 250° C., and advantageously the dissolution pressure, in particular between 1.0 and 100.0 MPa, preferably between 1.0 and 25.0 MPa absolute, preferentially between 1.5 and 18.0 MPa absolute and very preferably between 2.0 and 15.0 MPa absolute. Very advantageously, at the end of the dissolution step, the crude polymer solution is at the dissolution temperature and the dissolution pressure.

Limiting the temperature in the dissolution step a) to a temperature of less than or equal to 300° C., preferably less than or equal to 250° C., makes it possible to avoid or limit the thermal degradation of the targeted thermoplastics, in particular of the targeted polyolefins, but also to limit the energy requirement of the process, thus helping to limit the operating costs of the process. Advantageously, the dissolution temperature is greater than or equal to the melting point of the targeted thermoplastics, in particular of the targeted polyolefins, so as to promote their dissolution and very advantageously reduce the residence time required to effectively dissolve said thermoplastics in the dissolution solvent. Very preferably, the temperature in the dissolution step a) is less than or equal to the critical temperature of the dissolution solvent, so as to avoid the formation of a supercritical phase during the dissolution step a) which is liable to disrupt the dissolution.

At the same time, the dissolution pressure in the dissolution step is higher than the saturating vapour pressure of the dissolution solvent at the dissolution temperature, so that the dissolution solvent is at least partly, and preferably entirely, in liquid or possibly supercritical form at the dissolution temperature, and thus to avoid the possibility of the dissolution solvent being partly in gaseous form. Thus, the dissolution of the targeted thermoplastics, in particular of the targeted polyolefins, is optimized, especially in terms of quality and operation time.

Advantageously, said dissolution step a) is performed for a residence time preferably of between 1 and 600 minutes, preferably between 2 and 300 minutes, preferably between 2 and 180 minutes. The residence time is understood as being the residence time at the dissolution temperature and at the dissolution pressure, i.e. the time of implementation of the plastic feedstock with the dissolution solvent at the dissolution temperature and at the dissolution pressure, in step a).

In order to enable the dissolution solvent and the plastic feedstock to be placed in contact with each other and, above all, to enable the targeted thermoplastics to be dissolved efficiently and homogeneously in the dissolution solvent, the dissolution step a) may advantageously involve various types of equipment such as mixing, transporting and heating devices, for instance a reactor, a pump, a transport circuit, a stirring system, an oven, an exchanger, a mixer, etc. In particular, step a) advantageously involves at least one item of dissolution equipment, and optionally at least one feedstock preparation device, a mixing device and/or a transporting device. These items of equipment and/or devices may be, for example, one or more static or dynamic mixers, an extruder, a pump, a reactor, a co-current or counter-current column, or a combination of lines and of equipment. Devices for transportation in particular of fluids, such as gases, liquids or solids, are well known to those skilled in the art. In a non-limiting manner, the transporting devices may comprise at least one of the following devices: a compressor, a pump, an extruder, a vibrating tube, an endless screw or a valve. The items of equipment and/or devices used in step a) may also comprise or be combined with heating systems (for example an oven, an exchanger, a tracing, etc.) to achieve the conditions required for dissolution.

The dissolution step a) is at least fed with the plastic feedstock, in particular in the form of one or more streams of plastic feedstock, and with the dissolution solvent, in particular in the form of one or more streams of dissolution solvent, advantageously by means of one or more transporting devices. The stream(s) of plastic feedstock may be distinct from the stream(s) of dissolution solvent. Some or all of the plastic feedstock may also feed step a) as a mixture with some or all of the dissolution solvent, the remainder of the solvent and/or of the feedstock, where appropriate, possibly feeding step a) separately.

During the placing of the plastic feedstock in contact with the dissolution solvent, the dissolution solvent is advantageously at least partly, and preferably totally, in liquid or possibly supercritical form, whereas the plastic feedstock, which comprises the targeted thermoplastics, may be in solid or liquid form optionally comprising solid particles in suspension. The plastic feedstock may also optionally be injected into the dissolution equipment, as a mixture with the dissolution solvent, in the form of a suspension in the dissolution solvent, the preparation and injection of the suspension possibly being continuous or batchwise.

Preferably, the dissolution step a) involves at least one means for at least partially melting the plastic feedstock, preferably an extruder, optionally at least one means for mixing at least part of the dissolution solvent and the advantageously at least partially melted plastic feedstock, such as one or a series of two to ten mixers (preferably one to ten static mixers), and dissolution equipment, for example at least one Continuous Stirred Tank Reactor (CSTR), equipped with at least one mechanical stirring system. In this case, the plastic feedstock feeds the melting means, in particular the extruder, so that, at the outlet of said means, at least some and preferably all of the targeted thermoplastics included in the plastic feedstock are in molten form. The plastic feedstock can then subsequently be injected into the dissolution equipment or optionally into a system comprising a mixer or a series of mixer(s) advantageously followed by dissolution equipment. The plastic feedstock, at least partly in molten form, may also be pumped by means of a pump dedicated to viscous fluids, often known as a melt pump or a gear pump. The plastic feedstock at least partly in molten form may, at the outlet of said melting means, also be filtered by means of a filtration device, optionally in addition to the melt pump, for the purpose of removing the coarsest particles; generally, the mesh size of this filter is between 10 μm (micrometres) and 1 mm (millimetre), preferably between 20 and 200 μm. At the same time, the dissolution solvent is fed directly to the dissolution equipment or possibly the mixer or the series of mixers.

Preferably, step a) implements, prior to at least one CSTR-type reactor, an extruder and at least one static mixer into which at least a fraction of the dissolution solvent is injected, so as to promote shearing and intimate mixing between the dissolution solvent and the plastic feedstock, thus contributing towards the dissolution of the targeted thermoplastics.

Very advantageously, the crude polymer solution obtained at the end of the dissolution step a) comprises at least the dissolution solvent and the targeted thermoplastics, in particular the targeted polyolefins, dissolved in the dissolution solvent. In general, the crude polymer solution also comprises soluble impurities that are also dissolved in the dissolution solvent and/or insoluble impurities in suspension. The crude polymer solution obtained at the end of the dissolution step a) may optionally also comprise polymers, for example in molten form, dissolved form or undissolved form.

### Step b) of Decantation of the Polymer Solution

The process according to the invention comprises a step b) of decanting the crude polymer solution obtained at the end of the dissolution step a), to at least generate one “decanted” polymer solution and a tailings fraction.

Indeed, the decantation step b) makes it possible, by modifying the differences in the densities of the compounds present in the crude polymer solution, to separate out at least some of the insoluble impurities that may be present in the crude polymer solution, in the form of solid particles, in particular in suspension, or in the form of a liquid phase, for example comprising a molten polymer, and optionally at least some of the soluble impurities, dissolved in the dissolution solvent. The decantation step b) thus makes it possible to recover a decanted polymer solution which is at least partly freed of the impurities present in the crude polymer solution which feeds said step b). The decantation step b) thus also generates a tailings fraction which comprises at least some, preferably all, of the insoluble impurities of the crude polymer solution obtained from step a), and possibly of the soluble impurities, and possibly of the dissolution solvent which may be partly entrained with the impurities. The insoluble impurities removed during decantation step b) are, for example, pigments, mineral compounds, packaging residues (glass, wood, cardboard, paper, aluminium) and polymers other than the targeted thermoplastics, in particular other than the targeted polyolefins.

According to one embodiment of the invention, the decanted polymer solution comprises a portion of the polyolefins contained in the initial plastic feedstock, for example the polypropylene of the plastic feedstock, while the tailings fraction comprises polymer impurities, in particular thermoplastics other than the targeted polyolefins, and/or another portion of the polyolefins contained in the initial plastic feedstock, for example polyethylene, and in particular high density polyethylene (HDPE), of the plastic feedstock. Said polymer impurities and/or said other portion of the polyolefins may notably not have been solubilized in the dissolution step a). The tailings fraction can then advantageously be recovered and treated in another process, for example a second process according to the invention, so as to purify said thermoplastics, in particular said other portion of the polyolefins of the initial plastic feedstock and separated in the tailings fraction.

Another advantage of the decantation step b) of the process according to the invention lies in the fact that it allows efficient, continuous purification of the polymer solution. This aspect is advantageous since the yield of purified targeted thermoplastics, in particular purified targeted polyolefins, is then optimal.

Advantageously, the decantation step b) makes it possible, in addition to continuously removing at least some of the impurities, to limit the operating problems, in particular such as clogging and/or erosion, of the downstream process steps, while at the same time efficiently contributing towards the purification of the plastic feedstock.

Advantageously, step b) is performed at a temperature of between 100° C. and 300° C., preferably between 150° C. and 250° C., and a pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute. Preferably, step b) is performed under the temperature and pressure conditions of the dissolution step a).

Step b) uses at least one item of decantation equipment, also known as a decanter. Preferably, step b) uses between one and ten decanters, preferentially between two and five decanters. When step b) uses several decanters, i.e. between two and ten, preferably between two and five decanters, said decanters can operate in series and/or in parallel, preferably in parallel.

Said decanter(s) is (are) preferably cylindrical or generally cylindrical in shape, closed at each end, in particular by hemispherical or conical ends, and advantageously comprising orifices, for example for the supply of crude polymer solution and for the outlet of the various separated streams. The term “generally cylindrical” means that the shape of the decanter is a cylinder closed at the ends, in particular by hemispherical ends or by a first hemispherical end and a second conical end. Very particularly, the decanter(s) used in step b) may be multi-cylindrical.

The expression “multi-cylindrical” means that the decanter in question may have several cylindrical sections of different diameters; for example, a first cylindrical zone of diameter D1 and a second cylindrical zone of diameter D2, with D1 greater than D2.

The or each decanter used in step b) may be a vertical or horizontal decanter. In other words, the or each decanter which is preferably of generally cylindrical shape is operated such that the cylinder is positioned vertically or horizontally, respectively.

Preferably, said decanter(s) used in step b), which preferably is (are) cylindrical or generally cylindrical in shape, has a ratio L/D between the total length L of the decanter in question (i.e. the total length of the closed cylinder, the ends being included) and the diameter (or width) D of the decanter in question which is between 0.5 and 12, preferably between 1.0 and 6.0.

Very particularly, the decanter(s) used in step b) may be one or more vertical decanters of multi-cylindrical form. The expression “multi-cylindrical” means that the decanter in question may have several cylindrical sections of different diameters; for example a first cylindrical zone of diameter D1 and a second cylindrical zone of diameter D2, with D1 greater than D2, the second cylindrical zone of diameter D2 preferably being located above (i.e. on the top side of the decanter) the first cylindrical zone of diameter D1. In this very particular embodiment, the diameter D to be considered is the diameter of the widest cylindrical section of said decanter considered, that is to say the diameter D1 of the decanter of the example mentioned above.

Step b) is fed with at least a fraction, or all, of the crude polymer solution obtained from step a). In the embodiment in which step b) uses a single decanter or several decanters in series, all of the crude polymer solution obtained at the end of step a) is fed to said decanter or to the first decanter of the series. In the embodiment in which step b) uses several decanters in parallel, the crude polymer solution obtained at the end of step a) feeds each decanter operating in parallel. In this latter embodiment, the crude polymer solution is advantageously divided into several partial streams of crude polymer solution, in particular into as many partial streams as there are decanters in parallel.

The (or each) decanter used in step b) is fed with polymer solution, in particular with crude polymer solution or with an effluent enriched in polymer solution, at a feed point located on the decanter in question.

When the decanter in question is a vertical decanter, said feed point for feeding with polymer solution is advantageously located between the upper quarter of the height of said decanter and the upper three quarters of the height of said decanter, preferably between the upper third of the height of said decanter and the upper two thirds of the height of said decanter. Said polymer solution feed point then defines two zones in the vertical decanter in question, an upper zone located between the polymer solution feed point and the top of the vertical decanter, and a lower zone located between the polymer solution feed point and the bottom of the vertical decanter.

When the decanter in question is a horizontal decanter, said polymer solution feed point is preferably located on one side of the horizontal decanter, that is to say at one of the ends of the horizontal decanter or close to one of the ends of the horizontal decanter, preferably in a zone between one of the two ends of the horizontal decanter and one third of the length of said decanter starting from said end, preferably lying between one of the two ends of the horizontal decanter and a quarter of the length of said decanter starting from said end.

The or each decanter comprises an outlet for an effluent enriched in polymer solution, i.e. an effluent comprising the polymer solution freed of at least some of the impurities. Thus, an effluent enriched in polymer solution is recovered at the outlet of the or of each decanter used in step b). The effluent enriched in polymer solution can be recovered by withdrawing or overspilling. When step b) uses a single decanter, the effluent enriched in polymer solution recovered at the outlet of said decanter thus constitutes the decanted polymer solution. When step b) uses several decanters in parallel, all the effluents enriched in polymer solution and recovered at the outlet of each decanter constitute the decanted polymer solution. Finally, when step b) uses several decanters in series, one after the other, the effluent enriched in polymer solution recovered at the outlet of the upstream decanter advantageously directly feeds the downstream decanter with polymer solution, and the effluent enriched in polymer solution recovered at the outlet of the last decanter of the series constitutes the decanted polymer solution.

When the decanter under consideration is a vertical decanter, the outlet for the effluent enriched in polymer solution is advantageously located in the upper zone of the vertical decanter in question, i.e. in a zone between the polymer solution feed point and the top of the decanter.

When the decanter under consideration is a horizontal decanter, the outlet for the effluent enriched in polymer solution is advantageously located on the side of the decanter opposite the polymer solution feed point, i.e. at or near the end of the decanter which is opposite the end towards which the polymer solution feed point is located, said outlet for the effluent enriched in polymer solution preferably being located in a zone between the end of the decanter opposite the end towards which the polymer solution feed point is located and one third of the length of the decanter from said opposite end, preferably between the end of the decanter opposite the end towards which the polymer solution feed point is located and one quarter of the length of the decanter from said opposite end.

The (or each) decanter also comprises a tailings stream outlet. Thus, a tailings stream is recovered from the outlet of the or of each decanter used in step b). When step b) uses a single decanter, the tailings stream recovered at the outlet of said decanter thus constitutes said tailings fraction obtained at the end of step b). When step b) uses several decanters in parallel or in series, all the tailings streams recovered at the outlet of each decanter constitute said tailings fraction obtained at the end of step b).

The tailings stream in the decanter under consideration may be recovered, or purged, continuously or batchwise. When the tailings stream is purged batchwise, the purge frequency may vary between 0.01 and 20.0 mHz, preferably 0.1 and 10.0 mHz, preferentially between 0.5 and 1.0 mHz.

When the decanter under consideration is a vertical decanter, the outlet for the tailings stream is advantageously located in the lower zone of the decanter (i.e. in the zone between the polymer solution feed point and the bottom of the decanter), preferably in the bottom of the decanter under consideration, for example in the bottom of the conical end of the vertical decanter.

When the decanter under consideration is a horizontal decanter, the outlet for the tailings stream is located in the bottom of the decanter under consideration and advantageously on the side of the decanter opposite the polymer solution feed point, i.e. close to the end of the decanter which is opposite the end towards which the polymer solution feed point is located, preferably in a zone between the end of the decanter opposite the end towards which the polymer solution feed point is located and one third of the length of the decanter from said opposite end, preferentially between the end of the decanter opposite the end towards which the polymer solution feed point is located and one quarter of the length of the decanter from said opposite end.

Said at least one decanter used in step b) is preferably operated with a filling ratio of between 70% and 100% of the total volume of the decanter under consideration. The term “filling ratio” corresponds to the ratio between the total volume of material (polymer solution and tailings) present in the decanter and the total volume of the decanter (i.e. geometric volume of the decanter).

In said at least one decanter used in step b), there is a liquid surface velocity (also known as the knockout drum velocity, in particular upward) which ranges between 1×10⁻⁷ and 1.000×10⁻² m/s, preferably between 1.0×10⁻⁶ and 1.000×10⁻² m/s, preferentially between 1.0×10⁻⁵ and 6.000×10⁻³ m/s, preferably between 2.0×10⁻⁵ and 5.000×10−3 m/s, very preferably between 2.0×10⁻⁵ and 9.00×10⁻⁴ m/s, in particular between 2.0×10⁻⁵ and 5.00×10⁻⁴ m/s. This liquid surface velocity, known as LSV (or Q/S), is well known to those skilled in the art and corresponds to the flow rate Q of liquid freed of at least some of the impurities divided by the cross-sectional area S of the decanter (in particular the widest cross section in the case of a multi-cylindrical decanter). In the case of a vertical decanter, the liquid surface velocity is adjusted so as to be less than or equal to a value equal to 0.85 times the sedimentation rate, preferably 0.80 times the sedimentation rate. In the case of a horizontal decanter, the liquid surface velocity is a function of the sedimentation rate but also of the length L of the horizontal decanter. The sedimentation rate advantageously corresponds to the speed, or average speed, at which the impurity particles sediment in the polymer solution. The sedimentation rate is thus more particularly a function of the gravitational force, the density, the diameter and concentration of the impurity particles under consideration and the viscosity of the medium, i.e. the polymer solution.

Very advantageously, said decanter(s) has (have) a speed of injection of the polymer solution, in particular of the crude polymer solution or of the effluent enriched in polymer solution, of less than or equal to 1.00 m/s, preferably less than or equal to 0.10 m/s, preferentially less than or equal to 0.05 m/s, and preferably greater than or equal to 0.0001, or even greater than or equal to 0.001 m/s.

Thus, in each decanter, the residence time can be adjusted to between 1 and 200 hours, preferably between 1 hour and 50 hours. The residence time corresponds here to the residence time in the decanter, namely the ratio between the working volume of the decanter (that is to say the volume of material in the decanter which is a function of the degree of filling of the decanter under consideration) and the volume flow rate of polymer solution (crude polymer solution or effluent enriched in polymer solution) feeding the decanter in question.

The tailings fraction can be recovered and treated so as to recover any solvent it may contain.

According to one embodiment of the invention, the tailings fraction may comprise polymer impurities, in particular thermoplastics other than the targeted polyolefins, or even polyolefins, for example polyethylene (PE) and in particular high density polyethylene (HDPE), which were contained in the plastic feedstock but which are not the specific polyolefins targeted. The tailings fraction can then advantageously be recovered and treated in another process, for example in a second process according to the invention, so as to purify said thermoplastics, in particular said polyolefins of the tailings fraction.

According to a particular embodiment, the object of the process according to the invention is to recover and purify the polypropylene (PP) of the plastic feedstock, said plastic feedstock possibly comprising other thermoplastics, or even other polyolefins, for example PE and in particular HDPE. Step a) is adjusted so as to make it possible to selectively dissolve said polypropylene of the plastic feedstock. The term “selective dissolution” is understood to mean that the majority of the PP, and possibly a minority fraction of PE, in particular HDPE, contained in the initial plastic feedstock, is (are) dissolved in the dissolution solvent, whereas the majority of the PE, in particular of the HDPE, and possibly a minority fraction of PP, contained in the initial plastic feedstock, is (are) undissolved. According to this particular embodiment, the dissolution temperature is preferably between 17° and 230° C., preferentially between 18° and 220° C., and the dissolution pressure is preferably between 1.5 and 10.0 MPa absolute, preferentially between 2.0 and 8.0 MPa absolute. Step b) then makes it possible to separate at least partially, preferably completely, the thermoplastics other than the targeted PP, for example makes it possible to separate the PE or HDPE. The tailings fraction recovered at the bottom of the decanter then advantageously comprises thermoplastics, other than the targeted PP, for example comprises PE and in particular HDPE. Said tailings fraction is then very advantageously recovered and treated in a process, for example another recycling process according to the invention, to separate and recover said thermoplastics, for example said PE or HDPE, in purified form.

The decanted polymer solution recovered at the end of step b) may optionally undergo a purification step or be sent directly to the solvent-polymer separation step c). Preferably, the decanted polymer solution recovered at the end of step b) is sent to a purification step b′), which very preferentially comprises an additional solid-liquid separation and/or an adsorption of notably soluble impurities.

Optional Step b′) of Purification of the Polymer Solution

The treatment process according to the invention may also comprise an additional step of purification of the decanted polymer solution. This optional purification step b′) comprises at least one of the sub-steps b′1), b′2), b′3) and b′4) described below:
b′1) an additional solid-liquid separation sub-step,
b′2) a washing sub-step, by contact with a dense solution,
b′3) an extraction sub-step, by contact with an extraction solvent,
b′4) a sub-step of adsorption of the impurities by contact with an adsorbent solid.

Incorporation into the process according to the invention of such a step b′) and in particular of one or more of the sub-steps b′1), b′2), b′3), b′4) very advantageously allows maximum purification of the polymer solution and thus helps to achieve the purity objective of the purified thermoplastic stream recovered at the process outlet, i.e. obtaining an impurity content of the purified thermoplastic stream of less than or equal to 5% by weight, preferably less than or equal to 1.0% by weight, preferentially less than or equal to 0.5% by weight. This optional step b′) thus makes it possible to obtain a “purified” polymer solution, which corresponds to a clarified polymer solution obtained from an additional solid-liquid separation sub-step b′1), a washed polymer solution obtained from a washing sub-step b′2), an extracted polymer solution obtained from an extraction sub-step b′3) or a refined polymer solution obtained from an impurity adsorption sub-step b′4).

Preferably, when it is incorporated into the process according to the invention, the purification step b′) comprises an additional solid-liquid separation sub-step b′1) and/or an impurity adsorption sub-step b′4). According to a very particular embodiment, the process according to the invention comprises an additional solid-liquid separation sub-step b′1) and/or an impurity adsorption sub-step b′4), and more particularly an additional solid-liquid separation sub-step b′1) followed by an impurity adsorption sub-step b′4).

Optional additional solid-liquid separation sub-step b′1) The purification process may comprise an additional solid-liquid separation sub-step b′1), to advantageously obtain at least one clarified polymer solution. Sub-step b′1) allows the removal of impurities that are typically insoluble in the dissolution solvent, which would not have been separated out in the decantation step b). Indeed, insoluble impurities, in the form of particles suspended in the crude polymer solution, may have densities lower than or too close to that of the polymer solution and thus cannot be separated, at least not effectively separated, during the decantation step b); they may thus remain suspended in the decanted polymer solution at the end of step b). Sub-step b′1) may then make it possible, when it is incorporated into the process according to the invention, to increase the efficiency of purification of the polymer solution and in particular the efficiency of separation of the insoluble impurities.

The optional sub-step b′1) may generate, in addition to the clarified polymer solution, an insoluble fraction. The insoluble fraction, when it is generated, advantageously comprises impurities, which are typically insoluble and not separated out in the decantation step b).

The optional sub-step b′1) is advantageously performed at a temperature of between 10° and 300° C., preferably between 15° and 250° C., and preferably at a pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute. Very advantageously, sub-step b′1) of separating out the insoluble matter is performed under the temperature and pressure conditions at the outlet of the dissolution step a), i.e. at the dissolution temperature and dissolution pressure as defined above.

When it is incorporated into the process, sub-step b′1) is preferably fed with the decanted polymer solution obtained from the decantation step b). According to another embodiment, sub-step b′1) may be fed with a washed polymer solution obtained from a washing sub-step b′2).

Advantageously, the optional sub-step b′1) includes a section comprising at least one item of solid-liquid separation equipment, for example chosen from a filter, a sand filter, a tangential filter notably using a membrane and/or a deep filter, optionally in the presence of filtration adjuvants (for example diatomaceous earth), an eddy current separator, an electrostatic separator, a triboelectric separator, preferably a filter, a sand filter and/or an electrostatic separator. Advantageously, a self-cleaning filter may be used, the cleaning or unclogging allowing the removal of the insoluble matter being performed using a solvent stream.

According to a particular embodiment, the optional sub-step b′1) includes at least two, and generally less than five, items of solid-liquid separation equipment in series and/or in parallel. The presence of at least two items of solid-liquid separation equipment in series makes it possible to improve the removal of the insoluble matter, whereas the presence of equipment in parallel makes it possible to manage the maintenance of said equipment and/or of the unclogging operations.

Certain insoluble impurities, in particular certain pigments and mineral fillers, conventionally added during the formulation of the polymers, may be introduced in the form of particles less than 1 μm in size. This is the case, for example, for titanium dioxide, calcium carbonate and carbon black. According to one particular embodiment, said sub-step b′1) of separation of the insoluble materials advantageously employs an electrostatic separator, which makes it possible to efficiently remove, at least in part, the insoluble particles less than 1 μm in size. According to another particular embodiment, sub-step b′1) of separating out the insoluble matter includes a sand filter, to remove the particles of different sizes and notably the particles less than 1 μm in size. According to yet another particular embodiment, sub-step b′1) of separation of the insoluble materials employs a tangential filter employing in particular a membrane and/or a depth filter, optionally in the presence of filtration adjuvants, such as diatomaceous earths.

Depending on the nature of the feedstock, the polymer solution which feeds sub-step b′1), preferably the decanted polymer solution, may optionally also comprise a second liquid phase, for example consisting of molten polymers, and of which the density is not sufficiently different from that of the polymer solution to be separated in step b). According to another particular embodiment, sub-step b′1) advantageously includes equipment for separating out a second liquid phase, preferably by means of at least one two-phase or three-phase separator.

Optional Washing Sub-Step b′2)

The treatment process may optionally also comprise a sub-step b′2) of washing with a dense solution, to advantageously obtain at least one washing effluent and one washed polymer solution. The washed polymer solution obtained at the end of sub-step b′2) advantageously comprises the targeted thermoplastics that the present invention seeks to recover purified, dissolved in the dissolution solvent. Optionally, the washed polymer solution may also comprise residual impurities which are in particular soluble in the dissolution solvent and/or optionally traces of the washing solvent if sub-step b′2) is performed.

The washing sub-step b′2) may be incorporated upstream or downstream, preferably downstream, of an additional solid-liquid separation sub-step b′1), when these two sub-steps are incorporated into the treatment process according to the invention.

When it is incorporated into the process, the washing sub-step b′2) is fed with a dense solution and with the decanted polymer solution obtained from step b) or optionally with the clarified polymer solution obtained from a sub-step b′1). The polymer solution fed to the washing sub-step b′2), in particular the decanted or optionally clarified polymer solution, may comprise insoluble impurities in suspension and/or dissolved impurities, that are not separated out in step b). These suspended or dissolved impurities may be partly or totally removed during the washing sub-step b′2) by dissolution or precipitation and/or by entrainment in the dense solution. Thus, when it is performed, this sub-step b′2) contributes towards the treatment of the plastic feedstock and more particularly towards the purification of the polymer solution.

The washing sub-step b′2) advantageously involves placing the decanted or optionally clarified polymer solution, which feeds sub-step b′2), in contact with a dense solution. Advantageously, the dense solution has a higher density than the polymer solution (i.e. the mixture comprising at least the targeted thermoplastics and the dissolution solvent in which the targeted thermoplastics are dissolved), in particular greater than or equal to 0.85, preferably greater than or equal to 0.9, preferentially greater than or equal to 1.0. The dense solution may be an aqueous solution, which preferably comprises at least 50% by weight of water, preferably at least 75% by weight of water, very preferably at least 90% by weight of water. The pH of the aqueous solution may be adjusted using an acid or a base so as to promote the dissolution of certain impurities. The dense solution may also optionally be a solution comprising, preferably consisting of, an organic solvent with a density advantageously greater than or equal to 0.85, preferably greater than or equal to 0.9, preferentially greater than or equal to 1.0, and in which the polymers of the plastic feedstock remain insoluble under the temperature and pressure conditions of sub-step b′2), for example an organic solvent chosen from sulfolane or N-methylpyrrolidone (NMP), optionally as a mixture with water. Very preferably, the dense solution is an aqueous solution which preferably comprises at least 50% by weight of water, preferably at least 75% by weight of water, very preferably at least 90% by weight of water. The washing sub-step b′2) is advantageously performed at a temperature of between 10° and 300° C., preferably between 15° and 250° C., and very advantageously at a pressure of between 1.0 and 100.0 MPa absolute, preferably between 1.0 and 25.0 MPa absolute, preferentially between 1.5 and 15.0 MPa absolute and very preferably between 2.0 and 15.0 MPa absolute. Very advantageously, the washing sub-step b′2) is performed at the dissolution temperature and the dissolution pressure.

In the washing sub-step b′2), when it is incorporated into the process, the mass ratio between the mass flow rate of the dense solution and the mass flow rate of the decanted or optionally clarified polymer solution which feeds sub-step b′2) is advantageously between 0.05 and 20.0, preferably between 0.1 and 10.0 and preferably between 0.5 and 3.0. The placing in contact between the decanted or optionally clarified polymer solution and the dense solution may be performed at several points in the equipment used, i.e. via several injections of the decanted or clarified polymer solution and/or of the dense solution at different points along the equipment; it is then the sum of the streams injected that is taken into account in the calculation of the ratio.

Sub-step b′2) may be performed in one or more items of washing equipment enabling the placing in contact with the dense solution and/or with separation equipment making it possible to recover at least one washing effluent and one washed polymer solution. This equipment is well known, for example stirred reactors, static mixers, decanting mixers, two-phase or three-phase separating vessels, co-current or counter-current washing columns, plate columns, stirred columns, packed columns, pulsed columns, etc., each type of equipment possibly comprising one or more items of equipment used alone or in combination with equipment of another type.

According to a preferred embodiment, the washing sub-step b′2) is performed in a counter-current washing column in which the dense solution is injected, preferably into the half, preferably the third, of the column that is the closest to the top of the column, on the one hand, and the decanted or clarified polymer solution is injected, preferably into the half, preferably the third, of the column that is the closest to the bottom of the column, on the other hand.

According to this embodiment, it is possible to recover at least one washed polymer solution and one washing effluent. According to a very particular embodiment, the streams at the washing column inlet and/or outlet may be divided and injected at several injection points along the column and/or withdrawn at several withdrawal points along the column.

According to another embodiment, the washing sub-step b′2) is performed in a mixer-decanter comprising a stirred mixing zone, to place the dense solution and the decanted or clarified polymer solution in contact, and a decantation zone, making it possible to recover a washed polymer solution and a washing effluent.

At the end of the washing sub-step b′2), the washing effluent obtained advantageously comprises impurities dissolved in the dense solvent and/or insoluble impurities entrained in the washing effluent. The washing effluent may be retreated in a washing treatment section, on the one hand to at least partly separate out the dissolved and/or entrained impurities and optionally to purify the washing effluent, to obtain a purified dense solution, and on the other hand to recycle at least a portion of the purified washing solution. This washing treatment section may include one or more items of equipment that are well known for solid-liquid separation, for example a separating vessel, a decanter, a centrifugal decanter, a centrifuge or a filter. The washing effluent may also be sent outside the process, for example to a used water treatment station when the dense solution is an aqueous solution.

Optional Extraction Step b′3)

The process according to the invention may comprise a sub-step b′3) of extraction by placing in contact with an extraction solvent, to obtain at least one extracted polymer solution and one spent solvent. The extracted polymer solution obtained at the end of sub-step b′3) advantageously comprises the targeted thermoplastic polymers which the present invention seeks to recover purified, dissolved in the dissolution solvent. The spent solvent is advantageously charged with impurities. Optionally, the extracted polymer solution may also comprise residual impurities which are in particular soluble in the dissolution solvent and/or traces of the washing solvent and/or of the extraction solvent if sub-step(s) b2) and/or b3) is (are) performed.

When it is incorporated into the process according to the invention, the extraction sub-step b′3) is advantageously positioned between the decantation step b) and the solvent-polymer separation step c), optionally upstream or downstream of an adsorption sub-step b′4) if the latter is also incorporated into the process, and preferably downstream of an additional solid-liquid separation sub-step b′1).

The extraction sub-step b′3) is advantageously fed with an extraction solvent and with the decanted polymer solution obtained from step b), the clarified polymer solution obtained from sub-step b′1), the washed polymer solution obtained from sub-step b′2) or the refined polymer solution obtained from an adsorption sub-step b′4). The polymer solution which feeds sub-step b′3), preferably the decanted polymer solution or optionally the clarified, washed or refined solution, may thus also comprise dissolved impurities. These dissolved impurities may be partly or totally removed during the extraction sub-step b′3) by placing in contact with an extraction solvent.

When it is incorporated into the process according to the invention, the extraction sub-step b′3) advantageously involves at least one extraction section, preferably between one and five extraction sections, very preferably one extraction section.

The mass ratio between the mass flow rate of the extraction solvent and the mass flow rate of the polymer solution which feeds b′3), preferably the decanted polymer solution or optionally the clarified, washed or refined polymer solution, is advantageously between 0.05 and 20.0, preferably between 0.1 and 10.0 and preferably between 0.2 and 5.0. The placing in contact between the polymer solution which feeds sub-step b′3) and the extraction solvent may be performed at several points in the extraction section, i.e. via several injections of the polymer solution and/or of the extraction solvent at different points along the extraction section; it is then the sum of the streams injected that is taken into account in the calculation of the ratio.

The extraction solvent used in the extraction sub-step b′3) advantageously comprises an organic solvent or a mixture of organic solvents. Preferably, the extraction solvent comprises, and preferably consists of, at least one preferably aliphatic and in particular paraffinic (i.e. saturated), preferably linear or branched hydrocarbon-based compound. Preferably, the extraction solvent comprises at least 80% by weight, preferentially at least 95% by weight, with preference 98% by weight of at least one preferably aliphatic and in particular paraffinic, preferably linear or branched hydrocarbon-based compound, the percentages being expressed relative to the total weight of the dissolution solvent (100% being the maximum). Preferably, the extraction solvent comprises at least one preferably aliphatic and in particular paraffinic hydrocarbon-based compound with a boiling point of between −50 and 250° C., preferably between −15 and 150° C., preferentially between −1 and 110° C. and preferably between 2° and 100° C. (at atmospheric pressure, in particular at 0.1 MPa). Preferably, the extraction solvent comprises, preferably consists of, at least one aliphatic, in particular paraffinic, preferably linear or branched hydrocarbon-based compound containing between 3 and 12 carbon atoms, preferentially between 4 and 8 carbon atoms. For example, the extraction solvent comprises a compound chosen from the isomers of butane, pentane, hexane and heptane. The extraction solvent may comprise, preferably consist of, a mixture of isomers of butane, pentane, hexane, heptane and octane, and preferably in a content of said mixture of isomers in the extraction solvent of greater than or equal to 80% by weight, preferentially greater than or equal to 95% by weight, preferably greater than or equal to 98% by weight, relative to the total weight of the extraction solvent. Preferably, the extraction solvent is a paraffinic aliphatic compound, having a critical temperature (temperature at the critical point of said pure hydrocarbon-based compound) preferably between 95 and 350° C., preferentially between 13° and 300° C., preferably between 18° and 285° C.

Very preferably, the extraction solvent used in the optional sub-step b′3) is the same solvent as the dissolution solvent used in step a), optionally in a different physical state (for example the extraction solvent in supercritical form relative to the dissolution solvent in liquid form), so as to facilitate the management of the solvents and notably their purification and their recycling in particular into the dissolution step a) and optionally into the extraction sub-step b′3). Another advantage of using identical dissolution and extraction solvents, in identical or different physical states, is, in addition to facilitating the management of the solvents involved in the process according to the invention, in particular the recovery of the solvents, their treatment and their recycling into at least one of the steps of the process, and that of limiting the energy consumptions and the costs generated in particular by the treatment and purification of the solvents.

The extraction section(s) of the optional sub-step b′3) may comprise one or more items of extraction equipment, enabling the placing in contact with the extraction solvent and/or with separation equipment for recovering at least one spent solvent, in particular charged with impurities, and an extracted polymer solution. This equipment is well known, for example stirred reactors, static mixers, decanting mixers, two-phase or three-phase separating vessels, co-current or counter-current washing columns, plate columns, stirred columns, packed columns, pulsed columns, etc., each type of equipment possibly comprising one or more items of equipment used alone or in combination with equipment of another type.

According to a preferred embodiment of b′3), the extraction is performed in a counter-current extraction column where the extraction solvent is injected, on the one hand, and the polymer solution which feeds sub-step b′3) is injected, on the other hand. According to this embodiment, it is possible to recover at least one extracted polymer solution, on the one hand, and a spent solvent notably charged with impurities, on the other hand. Preferably, the polymer solution which feeds b′3), preferably the decanted or optionally clarified, washed or refined polymer solution, is injected into the upper half, preferably the upper third, of the column, i.e. the half, preferably the third, that is the closest to the top of the counter-current extraction column, whereas the extraction solvent is injected into the lower half, preferably the lower third, of the column, i.e. the half, preferably the third, that is the closest to the bottom of the counter-current extraction column.

The streams at the counter-current extraction column inlet and/or outlet may be divided at several injection points and/or withdrawal points along the column.

According to another embodiment of b′3), the extraction is performed in a mixer-decanter which advantageously comprises a stirred mixing zone for placing in contact the extraction solvent and the polymer solution which feeds b′3), preferably the decanted or optionally clarified, washed or refined polymer solution, and a decantation zone making it possible to recover an extracted polymer solution, on the one hand, and a spent solvent, on the other hand.

Advantageously, the extraction sub-step b′3) is performed under temperature and pressure conditions that are different from the temperature and pressure conditions of the dissolution step a).

According to a preferred embodiment of b′3), the extraction sub-step b′3) involves a liquid/liquid extraction section. Preferably, the liquid/liquid extraction section is operated at a temperature of between 100° C. and 300° C., preferably between 150° C. and 250° C. and at a pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute. In any case, in this embodiment, the temperature and pressure conditions are adjusted so that the extraction solvent is in liquid form, the dissolution solvent preferably also being in liquid form. Very advantageously, the liquid/liquid extraction, in particular when the extraction solvent is the same as the dissolution solvent, is performed under temperature and pressure conditions that are different from the dissolution conditions achieved in step a), in particular at a temperature above the dissolution temperature and/or at a pressure below the dissolution pressure, so as thus to be in a two-phase zone of the corresponding polymer-solvent mixture diagram.

According to another preferred embodiment of b′3), the extraction sub-step b′3) includes a section for extraction under particular temperature and pressure conditions in which the extraction solvent is advantageously at least partly in supercritical form. Such an extraction may be referred to as supercritical extraction. In this embodiment, the extraction is performed by placing the polymer solution, preferably the decanted or optionally clarified, washed or refined polymer solution, in contact with an extraction solvent, advantageously under temperature and pressure conditions which make it possible to obtain a supercritical phase predominantly (i.e. preferably at least 50% by weight, preferentially at least 70% by weight, preferably at least 90% by weight) composed of the extraction solvent. In other words, in this embodiment, the extraction is performed by placing the polymer solution, preferably the decanted or optionally clarified, washed or refined polymer solution, in contact with an extraction solvent which is at least partly, preferably totally, in supercritical form. Such a supercritical extraction sub-step b′3) advantageously allows efficient purification of the polymer solution, notably due to the very high affinity of the organic impurities, such as some of the additives, notably certain colourants, plasticizers, etc., for the supercritical phase. The use of an extraction solvent in supercritical form also makes it possible to create a substantial density difference between the supercritical phase and the polymer solution in liquid form, which facilitates separation by decantation between the supercritical phase and the liquid phase, and this consequently contributes towards the purification of the polymer solution.

In this other preferred embodiment, sub-step b′3) uses an extraction solvent comprising at least 80% by weight, preferentially at least 95% by weight, preferably 98% by weight of at least one aliphatic paraffinic hydrocarbon-based compound (or alkane) (100% being the maximum, the percentages being expressed relative to the total weight of the extraction solvent) having a critical temperature preferably between 95 and 350° C., preferentially between 13° and 300° C., preferably between 18° and 285° C.

Advantageously, the supercritical extraction sub-step b′3) of this other particular embodiment is performed at a temperature preferably between 150° C. and 300° C., preferably between 180° C. and 280° C., and at a pressure preferably between 2.0 and 100.0 MPa absolute, preferably between 2.0 and 25.0 MPa absolute, preferably between 2.0 and 18.0 MPa absolute and very preferably between 3.0 and 15.0 MPa absolute. Very preferably, the operating pressure of such a supercritical extraction sub-step b′3) is between 2.7 MPa and 7.5 MPa absolute, preferentially between 3.0 MPa and 5.5 MPa absolute. In any case, in this embodiment, the temperature and pressure conditions are adjusted, notably in an adjustment section implemented in the extraction sub-step b′3) upstream of the extraction section, so that the extraction solvent is at least partly in the supercritical state in the extraction section.

In a particular embodiment, the extraction sub-step b′3) implements a supercritical extraction and the extraction solvent is the same as the dissolution solvent, except for the fact that the extraction solvent is at least partly in the supercritical phase. In this case of supercritical extraction, the dissolution solvent may become at least partly in supercritical form, advantageously optimizing the decantation during the extraction step, more particularly at each extraction phase or plateau, between the liquid phase and the supercritical phase, which thus makes it possible to maximize the purification.

Advantageously, at the end of the extraction sub-step b′3), the spent solvent obtained is in particular charged with soluble impurities. It may be retreated in an organic treatment section making it possible, on the one hand, to at least partly separate out the impurities and to purify the solvent to obtain a purified extraction solvent, and on the other hand to recycle at least a portion of the purified extraction solvent to the inlet of the extraction b′3), and/or to the inlet of the dissolution step a) in the case where the dissolution solvent and the extraction solvent are identical. The spent solvent may be treated according to any method known to those skilled in the art, for instance one or more methods from among distillation, evaporation, extraction, adsorption, crystallization and precipitation of insoluble matter, or by purging.

Optional Adsorption Sub-Step b′4)

The treatment process according to the invention may comprise an adsorption sub-step b′4), for obtaining a refined polymer solution. The refined polymer solution obtained at the end of optional sub-step b′4) advantageously comprises the targeted thermoplastic polymers, in particular the targeted polyolefins, dissolved in the dissolution solvent.

When it is incorporated into the process according to the invention, the adsorption sub-step b′4) is preferably performed downstream of the decantation step b) and upstream of the solvent-polymer separation step c). It may, however, be performed upstream of the decantation step b) and/or during the dissolution step a), by introducing adsorbent particles as a mixture with the crude polymer solution, said adsorbent particles being removed during the decantation step b) and possibly during an additional solid-liquid separation sub-step b′1) or even during a washing sub-step b′2). The adsorption sub-step b′4) may also optionally be performed upstream or downstream of an extraction sub-step b′3). Thus, when it is incorporated into the process according to the invention, the adsorption sub-step b′4) is performed by bringing the polymer solution which feeds it into contact with one or more adsorbents.

The optional adsorption sub-step b′4) advantageously includes an adsorption section operated in the presence of at least one adsorbent, which is preferably solid, and in particular in the form of a fixed bed, an entrained bed (or slurry, i.e. in the form of particles introduced into the stream to be purified and entrained with this stream) or in the form of an ebullated bed, preferably in the form of a fixed bed or an entrained bed. The adsorbent(s) used in sub-step b) is (are) preferably an alumina, a silica, a silica-alumina, an active charcoal, a decolourizing earth, or mixtures thereof, preferably an active charcoal, a decolourizing earth or mixtures thereof, preferably in the form of a fixed bed or an entrained bed, the circulation of the streams possibly being ascending or descending.

Advantageously, when it is incorporated into the process, the adsorption sub-step b′4) is performed at a temperature of between 10° and 300° C., preferably between 15° and 250° C., and at a pressure of between 1.0 and 100.0 MPa absolute, preferably between 1.0 and 25.0 MPa absolute, preferentially between 1.5 and 18.0 MPa absolute and very preferably between 2.0 and 15.0 MPa absolute. Very advantageously, the adsorption sub-step b′4) is performed under the dissolution temperature and pressure conditions, i.e. at the dissolution temperature and dissolution pressure reached in step a). Preferably, in the optional sub-step b′4), the hourly space velocity (or HSV), which corresponds to the ratio between the volume flow rate of the polymer solution which feeds b′4) and the volume of adsorbent, advantageously operating in b′4), is between 0.05 and 10 h⁻¹, preferentially between 0.1 and 5.0 h⁻¹.

According to a particular embodiment of sub-step b′4), the adsorption section may comprise one or more fixed beds of adsorbent, for example in the form of adsorption columns, preferably at least two adsorption columns, preferentially between two and four adsorption columns, containing said adsorbent(s). When the adsorption section comprises two adsorption columns, one operating mode may be that referred to as “swing” operating according to the dedicated terminology, in which one of the columns is on-line, i.e. in service, while the other column is in reserve. When the adsorbent of the on-line column is spent, this column is isolated, while the column in reserve is brought on-line, i.e. in service. The spent adsorbent can then be regenerated in situ and/or replaced with fresh adsorbent so that the column containing it can once again be brought on-line once the other column has been isolated.

Another mode of functioning of this particular embodiment of b′4) is to have at least two adsorbent columns functioning in series. When the adsorbent of the column placed at the top is spent, this first column is isolated and the spent adsorbent is regenerated in situ or replaced with fresh adsorbent. The column is subsequently brought back on-line in the last position, and so on. This operation is referred to as permutable mode, or as PRS for permutable reactor system or else as “lead and lag”. The combination of at least two adsorption columns makes it possible to overcome the possible and potentially rapid poisoning and/or clogging of the adsorbent due to the combined action of the impurities, of the contaminants and of the insoluble matter that may be present in the stream to be treated. The reason for this is that the presence of at least two adsorption columns facilitates the replacement and/or the regeneration of the adsorbent, advantageously without interruption of the process, also making it possible to control the costs and to limit the consumption of adsorbent.

### Step c) of Solvent-Polymer Separation

According to the invention, the process comprises a solvent-polymer separation step c), to obtain at least one stream of purified thermoplastic polymers, more particularly at least one stream of purified polyolefins and preferably at least one solvent fraction. This step c) is downstream of the decantation step b), or possibly of a step b′) for purifying the decanted polymer solution.

The solvent-polymer separation step c) is directed towards at least partly, preferably predominantly or even totally, separating out the solvent(s), in particular the dissolution solvent, contained in the decanted or purified polymer solution which feeds step c), so as to recover the targeted thermoplastics which have been at least partly, preferably totally freed of the impurities and of the dissolution solvent and possibly of the other solvent(s) used in the process (i.e. the extraction solvent and/or the dense solution). The term “predominantly” should be understood as meaning at least 50% by weight, preferentially at least preferably at least 70% by weight, preferably at least 90% by weight, very preferably at least 95% by weight, relative to the weight of the solvent(s) contained in the decanted or purified polymer solution which feeds step c), in particular of the dissolution solvent and optionally of the extraction solvent and/or of the dense solution contained in the decanted or purified polymer solution which feeds step c).

Any solvent-polymer separation method known to those skilled in the art may be performed, notably any method enabling a phase change of the polymers or of the solvent(s). The solvent(s) can be separated, for example, by flash evaporation of the solvents, atomization, stripping, crystallization of the polymers and solid-liquid separation, demixing, a difference in density and notably decantation or centrifugation, etc. Step c) can implement several separation operations in series. For example, step c) may comprise a solvent-polymer separation by demixing at least a portion of the solvent(s) in supercritical form, the solvent(s) being in supercritical form after adjustment of the temperature and/or pressure conditions in step c), preferably adjustment of the pressure and the temperature being maintained between 10° and 300° C., preferably between 15° and 250° C., so as to be under the supercritical conditions of at least one of the compounds of the solvent(s), followed by at least one separation of the residual solvent by evaporation, notably under pressure conditions lower than the pressure used for the transition to the supercritical state of the solvent, in particular at a pressure of between 4 and 0.000005 MPa (i.e. 5 Pa), preferably between 3 and 0.000005 MPa (i.e. 5 Pa), it being possible for the temperature to be maintained between 10° and 300° C., preferably between 15° and 250° C.

The stream of purified thermoplastic polymers obtained at the end of step c) may correspond to a concentrated polymer solution or to liquid (i.e. molten) or solid purified thermoplastic polymers. The solvent-polymer separation step c) may optionally also comprise a conditioning section for conditioning the thermoplastics, in particular the polyolefins targeted, recovered in solid form and more particularly in the form of solid granules. In this possible conditioning section, the recovered purified thermoplastic polymers are cooled, advantageously to a temperature below the melting point of the polymers, to obtain a fraction including thermoplastics in solid form.

The solvent-polymer separation step c) is also directed towards at least partly, preferably predominantly and preferentially totally recovering the solvent(s) contained in the decanted or purified polymer solution which feeds step c), and in particular the dissolution solvent and optionally the extraction solvent and/or the dense solution. The term “predominantly” should be understood as meaning at least 50% by weight, preferentially at least preferably at least 70% by weight, preferably at least 90% by weight, very preferably at least 95% by weight, relative to the weight of the solvent(s) contained in the decanted or purified polymer solution which feeds step c). Thus, step c) advantageously makes it possible to obtain at least one solvent fraction. The solvent-polymer separation step c) is also optionally directed towards purifying the recovered solvent fraction and recycling it, notably upstream of the dissolution step a) and possibly upstream of sub-step b′2) and/or of sub-step b′3).

Very advantageously, the solvent fraction recovered at the end of step c) may be treated in an organic treatment section located at the end of step c), so as to purify it and to obtain a purified solvent, in particular a purified dissolution solvent and optionally a dense purified solution and/or a purified extraction solvent, in order advantageously to be able to recycle it into the dissolution step a) and/or optionally into the washing sub-step b′2) or the extraction sub-step b′3). Said optional organic treatment section at the end of step c) may use any method known to those skilled in the art, for example one or more methods from among distillation, evaporation, liquid-liquid extraction, adsorption, crystallization and precipitation of insoluble matter, or by purging.

Thus, the process according to the invention makes it possible to obtain a stream of purified thermoplastic polymers, and more particularly of purified polyolefins, from any type of plastic feedstock and in particular from plastic waste. In particular, the process according to the invention makes it possible to remove at least 70% by weight, preferentially at least 80% by weight, of the impurities, and in particular of the inorganic impurities, contained in the plastic feedstock. The process according to the invention also makes it possible to remove organic compounds and notably insoluble polymers other than the targeted thermoplastics. Furthermore, very advantageously, the stream of purified thermoplastics, in particular of purified polyolefins, obtained at the end of the process is less coloured or is even decolourized relative to the plastic feedstock fed into the process according to the invention. The stream of purified thermoplastic polymers obtained at the end of the process according to the invention can then be used in any application, for example as a replacement for the same polymers in virgin form. The stream of purified thermoplastic polymers, obtained continuously via the process according to the invention, thus has an impurity content that is low enough for it to be able to be used in any application.

Very preferably, the stream of purified thermoplastic polymers obtained at the end of the process according to the invention advantageously has an impurity content of less than or equal to 5% by weight, very advantageously less than or equal to 1.0% by weight of impurities, or even less than or equal to 0.5% by weight of impurities. Very advantageously, the stream of purified thermoplastic polymers obtained at the end of the process according to the invention has a residual solvent content (in particular of dissolution solvent) of less than or equal to 5% by weight, preferably less than or equal to 1.0% by weight, preferably less than or equal to 0.1% by weight less than or equal to, or even a content of less than or equal to 500 ppm by weight, relative to the total weight of the stream of purified thermoplastics.

### Device

The present invention also relates to a device for treating a plastic feedstock to obtain a stream of purified thermoplastic polymers, which comprises:
means for contacting and at least partially dissolving the plastic feedstock in a dissolution solvent, such as an extruder, static mixer(s), one or more continuous stirred tank reactor(s) (CSTR), provided with suitable stirring system(s), so as to obtain a crude polymer solution;
a decanting device comprising at least one decanter (also called static decanter), preferably between one and ten decanter(s), preferentially between two and five decanters;
when the decanting device comprises several decanters, said decanters operating in series or in parallel, preferably in parallel,
said decanter(s) being vertical decanters or horizontal decanters, preferably cylindrical or generally cylindrical, or even multi-cylindrical, in shape, preferably with a ratio L/D between the total height or length L of the decanter and the diameter (or width) D of the decanter of between 0.5 and 12, preferably between 1.0 and 6.0,
said decanter(s) comprising a feed point, for being fed with polymer solution, in particular with crude polymer solution or with an effluent enriched in polymer solution,
advantageously, the feed point of the decanter or of the first decanter of the decanters in series or alternatively of each decanter in parallel being connected to said means for contacting and dissolving in order to feed said decanter(s) with at least a fraction, or all, of said crude polymer solution,
preferably, when the decanter in question is a vertical decanter, the feed point of said decanter is advantageously located between one quarter of the height of said decanter, starting from the top (or upper end) of said vertical decanter, and three quarters of the height of said decanter, starting from the top (or upper end) of said vertical decanter, preferably between one third of the height of said decanter, from the top (or upper end) of said vertical decanter, and the upper two thirds of the height of said decanter, starting from the top (or upper end) of said vertical decanter, said feed point then defining two zones in the vertical decanter in question, an upper zone located between the feed point and the top (or upper end) of the vertical decanter, and a lower zone located between the feed point and the bottom (or lower end) of the vertical decanter,
preferably, when the decanter in question is a horizontal decanter, the feed point of said decanter is advantageously located towards one end of the horizontal decanter in question, that is to say at one of the ends of the horizontal decanter or close to one of the ends of the horizontal decanter, preferably in a zone between one of the two ends of the horizontal decanter and one third of the length of said decanter starting from said end, preferably lying between one of the two ends of the horizontal decanter and a quarter of the length of said decanter starting from said end,
said decanter(s) comprising a first outlet for an effluent enriched in polymer solution and a second outlet for a tailings stream,
when the decanting device comprises several decanters in series, the first outlet (i.e. the outlet for the effluent enriched in polymer solution) of the downstream decanter is advantageously connected to the feed point of the decanter directly upstream (i.e. the first outlet of the decanter i is connected to the feed point of the decanter i+1), except for the last decanter of the series, for which the first outlet (i.e. the outlet for the effluent enriched in polymer solution) is connected to means located downstream of the decanting device, in particular solvent-polymer separation means or optionally an additional purification system,
when the decanting device comprises several decanters in parallel, all of said first outlets (i.e. the outlets for the effluent enriched in polymer solution) of said decanters are connected to one another and to a mixing system for mixing all the effluents enriched in polymer solution that are recovered at the outlet of said decanters in parallel, said mixing system being very advantageously connected to means located downstream of the decanting device, in particular solvent-polymer separation means or optionally an additional purification system,
preferably, when the decanter in question is a vertical decanter, the first outlet (i.e. outlet for the effluent enriched in polymer solution) of said decanter is advantageously located in the upper zone of the vertical decanter in question, that is to say in a zone between the feed point and the top (or upper end) of the vertical decanter, and the second outlet is advantageously located in the lower zone of the vertical decanter, preferably in the bottom (or lower end) of the vertical decanter,
preferably, when the decanter in question is a horizontal decanter, the first outlet (i.e. outlet for the effluent enriched in polymer solution) of said decanter and preferably the second outlet, is (are) advantageously located towards the end opposite the feed point, that is to say at the end or close to the end which is opposite to the end towards which the feed point is located, preferably said first outlet and preferably said second outlet, is (are) located in an area between the end opposite the feed point and one third of the length of the decanter starting from said opposite end, preferably between the end opposite the feed point and one quarter of the length of the decanter starting from said opposite end,
said decanter(s) being designed to have:
a liquid surface velocity ranging between 1×10⁻⁷ and 1.000×10⁻² m/s, preferably between 1.0×10⁻⁶ and 1.000×10⁻² m/s, preferentially between 1.0×10⁻⁵ and 6.000×10⁻³ m/s, preferably between 2.0×10⁻⁵ and 5.000×10⁻³ m/s, very preferably between 2.0×10⁻⁵ and 9.00×10⁻⁴ m/s, in particular between 2.0×10⁻⁵ and 5.00×10⁻⁴ m/s,
preferably, an injection speed of less than or equal to 1.00 m/s, preferably less than or equal to 0.10 m/s, preferentially less than or equal to 0.05 m/s, and preferably greater than or equal to 0.001 m/s;
optionally an additional purification system, located downstream of the decanting device, and comprising in particular additional solid-liquid separation means, for example filters, washing means, extraction means and/or adsorption means, when said additional purification system comprises several means, said means operate in series with each other;
solvent-polymer separation means, located downstream of the decanting device, for separating a solvent stream comprising in particular the dissolution solvent and a stream of purified thermoplastic polymers, in particular a stream of purified polyolefins, said solvent-polymer separation means being advantageously connected to said decanting device or optionally to said additional purification system.

Preferably, the treatment device comprises at least one additional purification system, preferably comprising additional solid-liquid separation means, for example filters and/or adsorption means, preferentially additional solid-liquid separation means and then adsorption means.

Said device for treating a plastic feedstock also advantageously comprises means for transport between said means and devices.

The examples and figures that follow illustrate the invention, notably particular embodiments of the invention, without limiting the scope thereof.

### LIST OF THE FIGURES

FIG. 1 represents the diagram of a decanter used according to an embodiment of the process of the present invention, in which the decanter is a vertical decanter, which is generally cylindrical, the bottom of said decanter being conical and the top end being hemispherical in shape. The decanter has a length L and a diameter D. It is fed with a polymer solution at the feed point 1. The effluent enriched in polymer solution is recovered at point 2 and the tailings purged at point 3.

FIG. 2 represents the diagram of a decanter used according to another embodiment of the process of the present invention, in which the decanter is a horizontal decanter, generally cylindrical, with ends which are hemispherical shape. The decanter has a length L and a diameter D. It is fed with a polymer solution at the feed point 1. The effluent enriched in polymer solution is recovered at point 2 and the tailings purged at point 3.

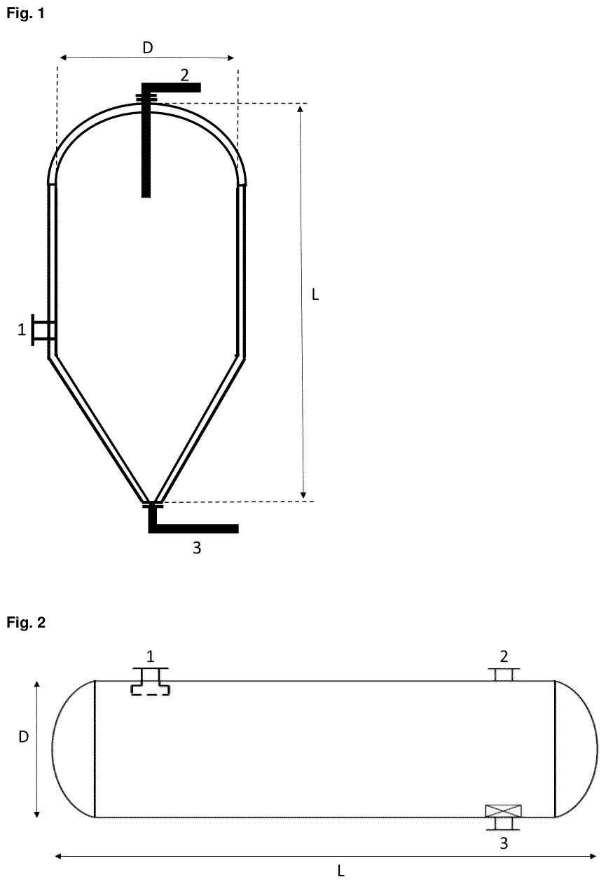

### EXAMPLES

In the examples below, the analyses carried out on the feedstock and the products obtained are as follows:
the ash content, which gives an indication of the content of inorganic impurities, is determined by thermogravimetric analysis (or TGA). The ash content is determined by thermogravimetric analysis (or TGA) using a Perkin Elmer TGA 8000 apparatus, according to the ISO 11358-1 standard (2014). A sample of 10-20 mg of material is placed on a platinum plate. The temperature is equilibrated at 50° C. for 10 minutes, then increases at a heating rate of 20° C./min to 950° C. under a nitrogen stream. The ash content corresponds to the weight determined at 850° C. relative to the weight of the starting sample, expressed as a percentage by weight (% by weight);
the contents of organic compounds, in particular of Irganox® 1010, Irgafos® 168, oxidized Irgafos®168, are determined by high performance liquid chromatography (HPLC);
the colour parameters are expressed in the CIE L*a*b* reference system (defined by the International Commission on Illumination (CIE)), determined by colorimetry (according to the ISO 11664-4 standard), with:
   a lightness (or luminance) parameter L*, such that the closer L* is to 100, the clearer or more transparent the analyzed solid; conversely, the closer L* is to 0, the more opaque the analyzed solid is;
   a parameter a* (corresponding to a green-red axis), which measures the colour ranging from green (negative values) to red (positive values); a target value for a* is a value approaching 0;
   a parameter b* (corresponding to a blue-yellow axis), which measures the colour ranging from blue (negative values) to yellow (positive values); a target value for b* is a value approaching 0.

The L*a*b* values are determined using a Standard Konica/Minolta Colorimeter CM-3700A instrument, on solid samples of approximately 20 g of cryomilled material.

### Example 1 (in Accordance with the Invention)

### Dissolution Step a):

A feedstock from plastic waste and containing 95% by weight of polypropylene (PP) is introduced in flake form into an extruder heated to 200° C. At the extruder outlet, the feedstock is at least partly in molten form and is mixed with n-heptane used as solvent and heated beforehand to 200° C., in a solvent/feedstock weight ratio of 5/1. The mixture comprising the solvent and the feedstock is introduced into a stirred reactor and heated to 200° C., and maintained at 2.0 MPa absolute, for a residence time of 1 hour. A crude polymer solution is then obtained.

### Decantation Step b):

The crude polymer solution obtained from the dissolution step a) is then subjected to a decantation step b):

The crude polymer solution is continuously withdrawn from the stirred reactor and injected into a static, vertical decanter with a ratio L/D between the total height and the diameter of the decanter that is generally cylindrical of 3.1. Said decanter is operated under the following conditions:
A temperature of 200° C.
A pressure of 2.0 MPa
An injection speed of 0.04 m/s
An upward knockout drum velocity of 0.07 mm/s
A residence time of 1 hour.

A “cake” is deposited at the bottom of the decanter: it comprises insoluble compounds, inorganic solids, a fraction of solvent, and organic elements. This “cake” is purged sequentially at a frequency of 0.8 mHz.

### Solvent-Polymer Separation Step c):

At the decanter outlet, the decanted polymer solution obtained from step b) is then subjected to a solvent-polymer separation step c).

At the process outlet, at atmospheric temperature and pressure, a solid A is obtained. The solid A is composed of polypropylene (PP). The solid A is analyzed. The results are summarized in Table 1 below. Table 1 compares the characteristics measured for the feedstock and for the solid A obtained, notably the ash content (which gives an indication of the content of inorganic impurities), the colorimetry parameters L, a and b and the relative weight amounts of three organic compounds (Irganox® 1010, Irgafos® 168 and oxidized Irgafos® 168).

TABLE 1

| | |
|---|---|
| Feedstock | Solid A |

Assessment of the insoluble inorganic elements

| | | | |
|---|---|---|---|
| Ash content | % by | 1.1 | 0.2 |
| | weight | | |

Assessment of the colours

| | | | |
|---|---|---|---|
| Cielab - L | ( ) | 57.47 | 88.65 |
| Cielab - a (red-green) | ( ) | 14.68 | 1.23 |
| Cielab - b (yellow-blue) | ( ) | 10.83 | 7.76 |

Assessment of the organic elements

| | | | |
|---|---|---|---|
| Irganox ® 1010 | ppm by | 1831 | 194 |
| | weight | | |
| Irgafos ® 168 | ppm by | 628 | 138 |
| | weight | | |
| oxidized Irgafos ® 168 | ppm by | 1899 | 505 |
| | weight | | |

The solid A obtained composed of polypropylene (PP) is purified relative to the plastic feedstock (see Table 1) since:
more than 80% by weight of inorganic impurities (100×(1.09−0.2)/1.09=81.65%) have been removed (solid A contains more than 80% by weight less inorganic impurities relative to the plastic feedstock);
the contents of the three organic impurities tested (Irganox® 1010, Irgafos® 168, oxidized Irgafos® 168) are also reduced in the solid A (194 ppm by weight, 138 ppm by weight and 505 ppm by weight, respectively) relative to the plastic feedstock (1831 ppm by weight, 628 ppm by weight and 1899 ppm by weight, respectively);
the solid A is also less coloured than the feedstock: the luminosity parameter L is increased for the solid A (88.65) and is close to 100 relative to that measured for the feedstock (57.47), whereas the parameters a and b are closer to the value 0 for the solid A (a=1.23 and b=7.76) compared to the feedstock (14.68 and 10.83, respectively).

### Example 2 (in Accordance with the Invention)

A feedstock from plastic waste, of the same type as that of Example 1, containing 95% by weight of polypropylene (PP) is introduced in flake form into an extruder heated to 200° C. At the extruder outlet, the feedstock is at least partly in molten form and is mixed with n-heptane used as solvent and heated beforehand to 200° C., in a solvent/feedstock weight ratio of 5/1. The mixture is then introduced into a stirred reactor and heated to 200° C., and maintained at 2.0 MPa absolute, for a residence time of 1 hour. A crude polymer solution is then obtained.

The crude polymer solution is continuously withdrawn from the stirred reactor and injected into a static, vertical decanter with a ratio L/D between the total height of the decanter and the diameter of the generally cylindrical decanter of 3.1. Said decanter is operated under the following conditions:
A temperature of 200° C.
A pressure of 2.0 MPa
An injection speed of 0.04 m/s
An upward knockout drum velocity of 0.07 mm/s
A residence time of 1 hour.

Impurities are deposited at the bottom of the decanter, forming a “cake” or “bed” which is purged batchwise at a frequency of 0.8 mHz.

At the decanter outlet, the decanted polymer solution is filtered through a filter with a 10 μm mesh aperture and then through a filter with a 1 μm mesh aperture.

The filtered polymer solution is then sent to an adsorption column containing a bed of activated carbon, and operated at 200° C. and 2.0 MPa.

The adsorbed polymer solution, recovered at the outlet of the adsorption column, is then subjected to a solvent-polymer separation step.

At the process outlet, and at atmospheric temperature and pressure, a solid B is obtained. The solid B is composed of polypropylene (PP). The solid B is analyzed, in the same way as the solid A of Example 1. The results are summarized in Table 2 below, which compares the characteristics measured for the feedstock and the solid B obtained, notably the ash content (which gives an indication of the content of inorganic impurities), the colorimetric parameters L, a and b and the relative weight amounts of three organic compounds (Irganox® 1010, Irgafos®168 and oxidized Irgafos® 168).

TABLE 2

| | |
|---|---|
| Plastic feedstock | Solid B |

Assessment of the insoluble inorganic elements

| | | | |
|---|---|---|---|
| Ash content | % by | 1.1 | 0.0 |
| | weight | | |

Assessment of the colours

| | | | |
|---|---|---|---|
| Cielab - L | ( ) | 57.47 | 92.89 |
| Cielab - a (red-green) | ( ) | 14.68 | −0.29 |
| Cielab - b (yellow-blue) | ( ) | 10.83 | 4.61 |

Assessment of the organic elements

| | | | |
|---|---|---|---|
| Irganox ® 1010 | ppm by | 1831 | 158 |
| | weight | | |
| Irgafos ® 168 | ppm by | 628 | 113 |
| | weight | | |
| oxidized Irgafos ® 168 | ppm by | 1899 | 494 |
| | weight | | |

The solid B obtained composed of polypropylene (PP) is purified relative to the plastic feedstock (see Table 2) since:
about 100% by weight of the inorganic impurities (100×(1.1-0.0)/1.1=100%) have been removed;
the contents of the three organic impurities tested (Irganox® 1010, Irgafos® 168, oxidized Irgafos® 168) are also reduced in the solid B (158 ppm by weight, 113 ppm by weight and 494 ppm by weight, respectively) relative to the plastic feedstock (1831 ppm by weight, 628 ppm by weight and 1899 ppm by weight, respectively);
the solid B is also less coloured than the feedstock and the colorimetric parameters are improved: the luminosity parameter L is increased for the solid B (98.89) and is close to 100 relative to that measured for the feedstock (57.47), whereas the parameters a and b are closer to the value 0 for the solid B (a=−0.29 and b=4.61) relative to the feedstock (14.68 and 10.83, respectively).

1. Process for treating a plastic feedstock, comprising:
a) a step of dissolving the plastic feedstock in a dissolution solvent, step a) being performed at a dissolution temperature of between 100° C. and 300° C. and at a dissolution pressure of between 1.0 and 100.0 MPa absolute, to obtain at least one crude polymer solution;
b) a step of decanting the crude polymer solution, to obtain a decanted polymer solution and a tailings fraction,
step b) being operated at a temperature of between 100° C. and 300° C. and a pressure of between 1.0 and 100.0 MPa absolute, and performing decanting with at least one decanter, when step b) is performed with several decanters, said decanters operate in series or in parallel,
the decanter or the first decanter of the decanters in series or each decanter in parallel being fed with at least one fraction of said crude polymer solution,
wherein an effluent enriched in polymer solution is recovered at the outlet of the or each decanter, wherein the effluent enriched in polymer solution recovered at the outlet of said decanter or of the last decanter of the decanters operating in series or else all the effluents enriched in polymer solution recovered at the outlet of each decanter operating in parallel, constitutes said decanted polymer solution,
a tailings stream being recovered at the outlet of the or of each decanter, all the tailings streams recovered constituting said tailings fraction,
said at least one decanter having a liquid surface velocity ranging between 1×10⁻⁷ and 1.000×10⁻² m/s; then
c) a step of solvent/polymer separation, to obtain at least one stream of purified thermoplastic polymers.

2. Process according to claim 1, in which the dissolution solvent and the plastic feedstock are fed into step a) in a weight ratio between the dissolution solvent and the plastic feedstock of between 0.2 and 100.0, preferably between 0.3 and 20.0, preferably between 1.0 and 10.0, even more preferentially between 3.0 and 7.0.

3. Process according to claim 1, in which the dissolution solvent comprises at least one hydrocarbon-based compound, said dissolution solvent having a boiling point of between −50° C. and 250° C., preferably between −15° C. and 150° C., preferentially between −1° C. and 110° C. and preferably between 20° C. and 100° C.

4. Process according to claim 1, in which the dissolution solvent comprises, preferably consists of, a mixture of isomers of butane, pentane, hexane, heptane and/or octane, and preferably an isomer or a mixture of isomers of hexane, heptane and/or octane.

5. Process according to claim 1, in which step b), performing decanting is with between one and ten decanters, preferentially between two and five decanters.

6. Process according to claim 1, in which each decanter of step b) is cylindrical or generally cylindrical in shape, having a ratio L/D between the total length L and the diameter D of the decanter of between 0.5 and 12, preferably between 1.0 and 6.0.

7. Process according to claim 1, in which the liquid surface velocity ranges in each decanter between 1.0×10⁻⁶ and 1.000×10⁻² m/s, preferably between 1.0×10⁻⁵ and 6.000×10⁻³, very preferably between 2.0×10⁻⁵ and 9.00×10⁻⁴ m/s.

8. Process according to claim 1, in which each decanter has an injection speed of less than or equal to 1.00 m/s, preferably less than or equal to 0.10 m/s, preferentially less than or equal to 0.05 m/s, and preferably greater than or equal to 0.001 m/s.

9. Process according to claim 1, in which each decanter is operated with a filling ratio of between 70% and 100% of the total volume of the decanter under consideration.

10. Process according to claim 1, comprising a step of purifying the decanted polymer solution to obtain a purified polymer solution, said purification step comprising:
b′1) an additional solid-liquid separation sub-step; and/or
b′2) a washing sub-step, by contact with a dense solution; and/or
b′3) an extraction sub-step, by contact with an extraction solvent; and/or
b′4) a sub-step of adsorption of the impurities by contact with a solid adsorbent.

11. Process according to claim 1, in which the plastic feedstock comprises thermoplastic polymers, more particularly polyolefins.

12. Device for treating a plastic feedstock to obtain a stream of purified thermoplastic polymers, comprising:
means for placing in contact and at least partially dissolving the plastic feedstock in a dissolution solvent, so as to obtain a crude polymer solution;
a decanting device comprising at least one decanter in which a liquid surface velocity ranges between 1×10⁻⁷ and 1.000×10⁻² m/s and preferably the injection velocity is of less than or equal to 1.00 m/s,
where the decanting device comprises several decanters, said decanters operating in series or in parallel,
said at least one decanter being a vertical or horizontal decanter, preferably cylindrical or generally cylindrical in shape, preferably with a ratio L/D between the total height or length L of the decanter and the diameter D of the decanter of between 0.5 and 12,
said decanter(s) comprising a polymer solution feed point,
said at least one decanter comprising a first outlet for an effluent enriched in polymer solution and a second outlet for a tailings stream,
when the decanting device comprises several decanters in series, the first outlet of the downstream decanter is advantageously connected to the feed point of the decanter directly upstream, except for the last decanter in the series for which the first outlet is connected to means located downstream of the decanting device,
when the decanting device comprises several decanters in parallel, all of said first outlets of said decanters are connected to one another and to a mixing system for mixing all of the effluents enriched in polymer solution that are recovered at the outlet of said decanters in parallel, said mixing system being connected to means located downstream of the decanting device;
optionally an additional purification system, located downstream of the decanting device;
solvent-polymer separation means, located downstream of the decanting device, for separating a stream of solvent and a stream of purified thermoplastic polymers.

13. Device according to claim 12, in which the liquid surface velocity in said at least one decanter ranges between 1.0×10⁻⁶ and 1.000×10⁻² m/s, preferably between 1.0×10⁻⁵ and 6.000×10⁻³, very preferably between 2.0×10⁻⁵ and 9.00×10⁻⁴ m/s.

14. Device according to claim 12, in which said at least one decanter is a vertical decanter, in which:
the feed point of said decanter is located between one quarter of the height of said decanter and three quarters of the height of said decanter, said feed point then defining two zones in the vertical decanter in question, an upper zone between the feed point and the top of the vertical decanter, and a lower zone between the feed point and the bottom of the vertical decanter, and
the first outlet of said decanter is located in the upper zone of the vertical decanter in question, and the second outlet is located in the lower zone of the vertical decanter.

15. Device according to claim 12, in which said at least one decanter is a horizontal decanter, in which:
the feed point of said decanter is located towards one end of the horizontal decanter in question,
the first outlet and the second outlet of said decanter are located towards the end opposite to the feed point.
